(19) United States
(12) Patent Application Publication
(10) Pub. No.: US 2025/0356318 A1
(43) Pub. Date: Nov. 20, 2025

(54) PRIVILEGE INFORMATION ISSUING APPARATUS, SYSTEM, AND METHOD, AND COMPUTER READABLE MEDIUM

(71) Applicant: NEC CORPORATION, Minato-ku, Tokyo (JP)

(72) Inventors: Eri KOKAJI, Tokyo (JP); Kazufumi HOSHI, Tokyo (JP); Yurie HOSHI, Tokyo (JP); Hiroaki KUJRAI, Tokyo (JP)

(73) Assignee: NEC CORPORATION, Minato-ku, Tokyo (JP)

(21) Appl. No.: 18/860,777

(22) PCT Filed: Jul. 28, 2022
(86) PCT No.: PCT/JP2022/029079

§ 371 Date: Oct. 28, 2024

(51) Int. Cl. G06Q 10/1093

(52) U.S. Cl. CPC G06Q 10/1093

(57) ABSTRACT

A privilege information issuing apparatus includes: an acquisition unit that acquires entry qualification information with which a person with a schedule of entry to an event venue can enter the event venue through identity authentication; a calculation unit that calculates an extra time until a clock time that is attributable to a start of the event from a clock time at which the person with the schedule of entry is scheduled to arrive or arrives in a predetermined region including the event venue on the basis of the entry qualification information; an issuing unit that issues privilege information that are able to be used in one or more commercial facilities in a neighborhood of the event venue on the basis of the extra time; and a notification unit that notifies a terminal of the person with the schedule of entry of the issued privilege information.

### TECHNICAL FIELD

The present disclosure relates to a privilege information issuing apparatus, a system, a method, and a program.

### BACKGROUND ART

Patent Literature 1 discloses a technology of providing coupons that can be used in restaurants near a station to people who move through a route from a departure point to a destination point while an event for which a large number of people gather at a specific location is held.

Here, a unique economic zone can be formed in a predetermined region including an event venue and commercial facilities around the event venue. In addition, management of entry to an event venue using identity authentication such as biometric authentication including face authentication has been put into practical use in recent years.

### CITATION LIST

### Patent Literature

Patent Literature 1: Japanese Unexamined Patent Application Publication No. 2016-042276

### SUMMARY OF INVENTION

### Technical Problem

Here, people with a schedule of entry to an event venue may arrive in the surroundings of the event venue in consideration of some extra time in order not to be late for an event start time and adjust their schedule. However, there is a problem that even if the people with a schedule of entry to the event venue arrive early before start of the event, they may not be able to find commercial facilities suitable for the schedule adjustment and may not be able to effectively use the spare time depending on a state of congestion on the day of the event.

In view of the above-described task, an object of the present disclosure is to provide a privilege information issuing apparatus, a system, a method, and a program to encourage a person with a schedule of entry to an event venue to use commercial facilities in the surroundings of the event venue and to thereby assist effective utilization of a spare time before a start of an event.

### Solution to Problem

A privilege information issuing apparatus according to the present disclosure includes:
an acquisition means for acquiring entry qualification information with which a person with a schedule of entry to an event venue where a predetermined event is held is able to enter the event venue through identity authentication;
a calculation means for calculating an extra time until a clock time that is attributable to a start of the event from a clock time at which the person with the schedule of entry is scheduled to arrive or arrives in a predetermined region including the event venue on the basis of the entry qualification information;
an issuing means for issuing privilege information that is able to be used in one or more commercial facilities in a neighborhood of the event venue on the basis of the extra time; and
a notification means for notifying a terminal of the person with the schedule of entry of the issued privilege information.

A privilege information issuing system according to the present disclosure includes:
a storage apparatus that stores entry qualification information with which a person with a schedule of entry is able to enter an event venue where a predetermined event is held through identity authentication, identity authentication information of the person with the schedule of entry who has purchased the entry qualification information, and a terminal that the person with the schedule of entry carries with himself/herself in an associated manner; and
a privilege information issuing apparatus that is connected to the storage apparatus,
in which the privilege information issuing apparatus includes
an acquisition means for acquiring the entry qualification information,
a calculation means for calculating an extra time until a clock time that is attributable to a start of the event from a clock time at which the person with the schedule of entry is scheduled to arrive or arrives in a predetermined region including the event venue on the basis of the entry qualification information,
an issuing means for issuing privilege information that is able to be used in one or more commercial facilities in a neighborhood of the event venue on the basis of the extra time, and
a notification means for notifying a terminal of the person with the schedule of entry of the issued privilege information.

A privilege information issuing method includes, by a computer:
acquiring entry qualification information with which a person with a schedule of entry to an event venue where a predetermined event is held is able to enter the event venue through identity authentication;
calculating an extra time until a clock time that is attributable to a start of the event from a clock time at which the person with the schedule of entry is scheduled to arrive or arrives in a predetermined region including the event venue on the basis of the entry qualification information;
issuing privilege information that is able to be used in one or more commercial facilities in a neighborhood of the event venue on the basis of the extra time; and
notifying a terminal of the person with the schedule of entry of the issued privilege information.

A privilege information issuing program that causes a computer to execute:
acquisition processing of acquiring entry qualification information with which a person with a schedule of entry to an event venue where a predetermined event is held is able to enter the event venue through identity authentication;
calculation processing of calculating an extra time until a clock time that is attributable to a start of the event from a clock time at which the person with the schedule of entry is scheduled to arrive or arrives in a predetermined region including the event venue on the basis of the entry qualification information;
issuing processing of issuing privilege information that is able to be used in one or more commercial facilities in a neighborhood of the event venue on the basis of the extra time; and
notification processing of notifying a terminal of the person with the schedule of entry of the issued privilege information.

### Advantageous Effects of Invention

According to the present disclosure, it is possible to provide a privilege information issuing apparatus, a system, a method, and a program to encourage a person with a schedule of entry to an event venue to use commercial facilities in surroundings of the event venue and to thereby assist effective utilization of a spare time before a start of an event.

### BRIEF DESCRIPTION OF DRAWINGS

FIG. 1 is a block diagram illustrating a configuration of a privilege information issuing apparatus according to a first example embodiment.

FIG. 2 is a flowchart illustrating a flow of a privilege information issuing method according to the first example embodiment.

FIG. 3 is a block diagram illustrating an overall configuration of a privilege information issuing system according to a second example embodiment.

FIG. 4 is a block diagram illustrating a configuration of an authentication apparatus according to the second example embodiment.

FIG. 5 is a block diagram illustrating a configuration of a user terminal according to the second example embodiment.

FIG. 6 is a block diagram illustrating a configuration of an entry control terminal according to the second example embodiment.

FIG. 7 is a block diagram illustrating a configuration of a payment terminal according to the second example embodiment.

FIG. 8 is a block diagram illustrating a configuration of a privilege information issuing apparatus according to the second example embodiment.

FIG. 9 is a flowchart illustrating a flow of member information registration processing according to the second example embodiment.

FIG. 10 is a flowchart illustrating a flow of face information registration processing performed by the authentication apparatus according to the second example embodiment.

FIG. 11 is a sequence diagram illustrating a flow of entry qualification information registration processing according to the second example embodiment.

FIG. 12 is a flowchart illustrating a flow of face authentication processing performed by the authentication apparatus according to the second example embodiment.

FIG. 13 is a flowchart illustrating a flow of privilege information issuing processing according to the second example embodiment.

FIG. 14 is a flowchart illustrating a flow of privilege information issuing processing according to the second example embodiment.

FIG. 15 is a diagram illustrating an example of relationships between positional relationships of an event venue, commercial facilities in a neighborhood, and a person with a schedule of entry and required times according to the second example embodiment.

FIG. 16 is a diagram illustrating a display example of privilege information according to the second example embodiment.

FIG. 17 is a diagram illustrating an example of relationships between positional relationships of an event venue, commercial facilities in a neighborhood, and a person with a schedule of entry and required times according to the second example embodiment.

FIG. 18 is a diagram illustrating a display example of privilege information according to the second example embodiment.

FIG. 19 is a flowchart illustrating a flow of privilege information issuing processing according to a third example embodiment.

FIG. 20 is a diagram illustrating a display example of privilege information according to the third example embodiment.

FIG. 21 is a diagram illustrating a display example of privilege information according to the third example embodiment.

FIG. 22 is a block diagram illustrating an overall configuration of a privilege information issuing system according to a fourth example embodiment.

FIG. 23 is a flowchart illustrating a flow of privilege information issuing processing according to the fourth example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

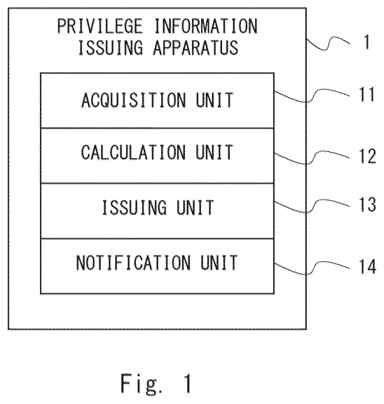

FIG. 1 is a block diagram illustrating a configuration of a privilege information issuing apparatus 1 according to a first example embodiment. The privilege information issuing apparatus 1 is an information processing apparatus that issues privilege information that can be used in predetermined commercial facilities. Here, the “commercial facilities” are stores, accommodation facilities, and the like that sell goods or provide services. The commercial facilities according to the first embodiment are assumed to be present in a region within a predetermined range from an event venue where a predetermined event is held, that is, in the neighborhood of the event venue. In addition, the “privilege information” is electronic data to which a right to enjoy a paid privilege or a free privilege in an available facility has been given. The privilege information is, for example, value added information such as an electronic coupon or a point.

The privilege information issuing apparatus 1 includes an acquisition unit 11, a calculation unit 12, an issuing unit 13, and a notification unit 14. The acquisition unit 11 acquires entry qualification information of an event venue. Here, the event venue is a facility where a predetermined event is held. Also, the “entry qualification information” is information with which a person with a schedule of entry can enter the event venue through identity authentication. Here, the “identity authentication” is information processing of verifying authenticity of an individual by collating identity authentication information registered in advance with information acquired from the individual or input from the individual at the time of the authentication and determining that a degree of matching is equal to or greater than a threshold value. Although examples of the identity authentication include biometric authentication such as face authentication, collation of code information (such as an ID or a password) presented or input by the individual, and the like, the identity authentication is not limited thereto.

The calculation unit 12 calculates an extra time until a clock time that is attributable to a start of the event from a clock time at which the person with the schedule of entry is scheduled to arrive or arrives in a predetermined region including the event venue on the basis of the entry qualification information. Here, the “time that is attributable to a start of the event” is a start time of the event, a start time of entry to the event venue, an available time zone for entry to the event venue, or the like. The issuing unit 13 issues privilege information that can be used in one or more commercial facilities in the neighborhood of the event venue on the basis of the extra time. The notification unit 14 notifies a terminal of the person with the schedule of entry of the issued privilege information.

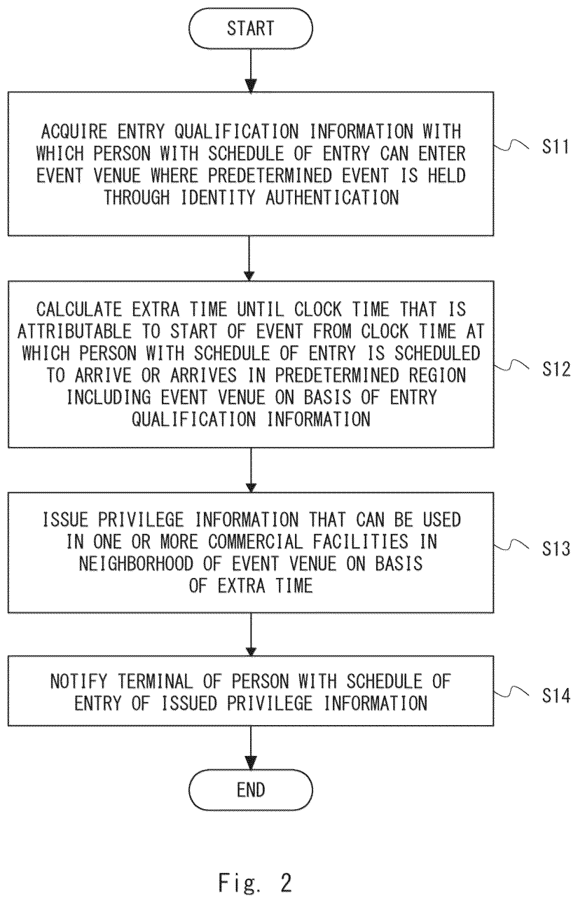

FIG. 2 is a flowchart illustrating a flow of privilege information issuing method according to the first example embodiment. First, the acquisition unit 11 acquires entry qualification information with which the person with the schedule of entry can enter the event venue where the predetermined event is held through identity authentication (S11). Next, the calculation unit 12 calculates the extra time until the clock time that is attributable to the start of the event from the clock time at which the person with the schedule of entry is scheduled to arrive or arrives in the predetermined region including the event venue on the basis of the entry qualification information (S12). Then, the issuing unit 13 issues the privilege information that can be used in one or more commercial facilities in the neighborhood of the event venue on the basis of the extra time (S13). Thereafter, the notification unit 14 notifies the terminal of the person with the schedule of entry of the issued privilege information (S14).

As described above, the person with the schedule of entry who has the entry qualification information for the predetermined event may arrive in the surroundings of the event venue in consideration of some extra time in order not to be late for the event start time on the day of the event. At this time, the privilege information issuing apparatus 1 issues the privilege information that can be used in a commercial facility that is suitable for schedule adjustment in accordance with the state of the surroundings of the event venue on the day of the event. The person with the schedule of entry can thus easily adjust their schedule in the commercial facility for which the privilege information is issued before the start of the event. Therefore, according to the present embodiment, it is possible to assist effective utilization of the spare time before the start of the event by encouraging the person with the schedule of entry to the event venue to use the commercial facility in the surroundings of the event venue.

Note that the privilege information issuing apparatus 1 includes a processor, a memory, and a storage apparatus as configurations, which are not illustrated. In addition, the storage apparatus stores a computer program that implements processing of the privilege information issuing method according to the present example embodiment. Then, the processor reads a computer program or the like from the storage apparatus into the memory and executes the computer program. In this manner, the processor implements the functions of the acquisition unit 11, the calculation unit 12, the issuing unit 13, and the notification unit 14.

Alternatively, each component of the privilege information issuing apparatus 1 may be implemented by dedicated hardware. In addition, some or all of the components of each apparatus may be implemented by general-purpose or dedicated circuitry, a processor, or a combination thereof. These may be configured of a single chip or may be configured of a plurality of chips connected via a bus. Some or all of the components of each apparatus may be implemented by a combination of the aforementioned circuitry or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the privilege information issuing apparatus 1 are implemented by a plurality of information processing apparatuses, circuits, or the like, the plurality of information processing apparatuses, circuits, or the like may be arranged in a centralized manner or in a distributed manner.

For example, the information processing apparatuses, the circuits, or the like may be implemented in the form of a client server system, a cloud computing system, or the like in which they are connected to each other via a communication network. The functions of the privilege information issuing apparatus 1 may be provided in a software as a service (SaaS) format.

### Second Example Embodiment

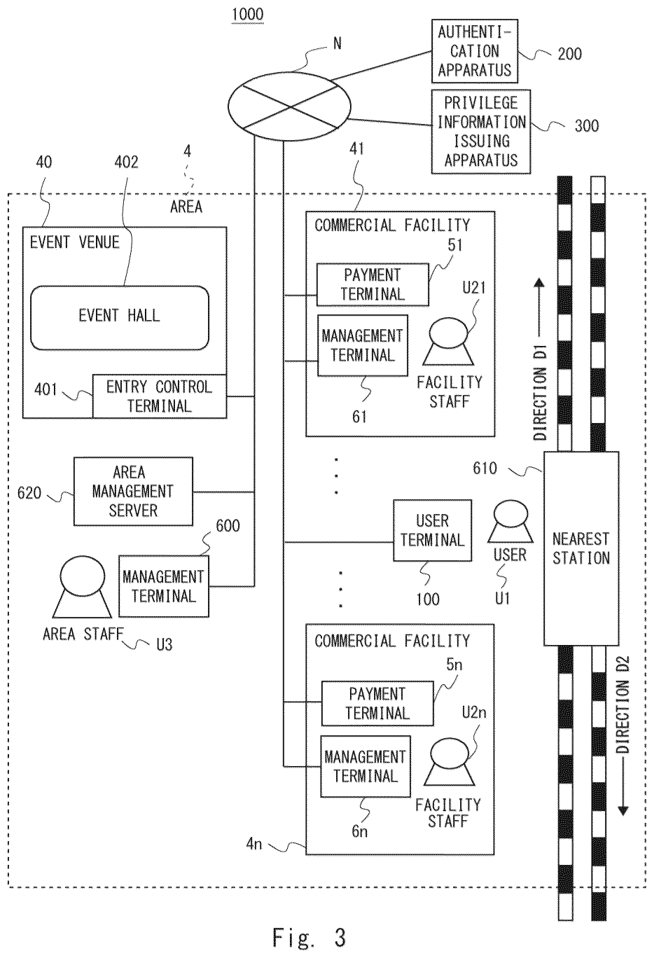

A second example embodiment is a specific example of the first example embodiment described above. FIG. 3 is a block diagram illustrating an overall configuration of a privilege information issuing system 1000 according to the second example embodiment. The privilege information issuing system 1000 is an information system that issues, for a user U1 who has purchased a paid electronic ticket (entry qualification information) for an event venue 40, a coupon that can be used in a commercial facility 41 or the like in a neighborhood before a start of an event and provides a notification to a user terminal 100. In this manner, the user U1 who has arrived at the nearest station 610 or the like of the event venue 40 earlier than the start of the event can effectively adjust their schedule. Also, privilege information with a time limit can promote a consumption action in the commercial facility 41 or the like in the neighborhood of the event venue 40. Therefore, it is possible to promote cooperative utilization of the event venue and the facilities and to support revitalization of the area 4 including the event venue 40 and the commercial facilities 41 to 4n (n is a natural number that is equal to or greater than one) in the neighborhood thereof.

The event venue 40 is a site where a predetermined event is held. The “event” is a paid service provided at a certain time by collecting a large number of people. For example, the event is a sport game, a concert, an exhibition, an international conference, a test, or the like, and may be watched or viewed by visitors who have made payment, or the visitors themselves may participate in the event. Therefore, the event venue 40 is a facility such as a sport stadium, a sport ground, an arena, a theater, or a multiuse event hall, for example. The event venue 40 can also be referred to as a main facility or a core facility in the area 4.

It is assumed that the event venue 40 includes an event hall 402 and an entry control terminal 401 is installed at an entrance. The entry control terminal 401 is an information terminal that permits entry to the event venue 40 in a case where the user U1 has succeeded in the person authentication. Details of the entry control terminal 401 will be described later. Note that some users entering the event venue 40 may enter without passing through the entry control terminal 401. In other words, the event venue 40 may allow users who have purchased conventional tickets or the like to enter without using identity authentication such as face authentication. The event hall 402 is a place where an event is held, a sport ground, an audience seat, or the like.

The commercial facilities 41 to 4n are facilities in the surroundings and commercial facilities in the neighborhood of the event venue 40. The number of commercial facilities 41 and the like may be at least one or more. The commercial facility 41 and the like are facilities in a cooperative relationship with the side of the event venue 40. Therefore, business operators of the commercial facility 41 and the like are business partners of a business operator on the side of the event venue 40. Examples of the commercial facility 41 and the like include, but are not limited to, retail stores, restaurants, shopping streets, shopping malls, accommodation facilities, parking lots, bicycle-parking lots, amusement parks, and the like.

In each of the commercial facilities 41 to 4n, at least each of payment terminals 51 to 5n compatible with the payment using face authentication is installed. In addition, each of the facility staff U21 to U2n performs a management operation such as registration and the like of privilege information that can be used in each of the commercial facilities 41 to 4n using each of management terminals 61 to 6n. The facility staff U21 and the like may also be shop staff of the commercial facility 41 and the like. Alternatively, the facility staff U21 and the like may be a cooperative business operator on the side of the commercial facility 41 and the like. Therefore, the facility staff U21 and the like and the management terminal 61 and the like may not necessarily be present inside the commercial facility 41 and the like.

The nearest station 610 is a public transportation station that is nearest to the event venue 40, and is, for example, a railway station, a bus stop, a taxi stand, a port, an airport, or the like. It is assumed that the nearest station 610 allows arrival and departure of different routes in directions D1 and D2, for example. A public transportation that operates the nearest station 610 may be a business partner with a business operator on the side of the event venue 40. In that case, an automatic ticket gate or the like installed at the nearest station 610 is a payment terminal (not illustrated) having a function that is similar to that of the payment terminal 51 or the like.

An area staff U3 is a business operator who manages business operations inside the area 4 including the event venue 40, the commercial facility 41, and the like. The area staff U3 may register the privilege information that can be used in the commercial facility 41 and the like using the management terminal 600.

An area management server 620 is a computer server that manages information regarding an event venue 40, a commercial facility 41, and the like included in the area 4, cooperative business operators, and the like. For example, the area management server 620 collects congestion states in the commercial facilities 41 to 4n in real time and provides the congestion states in response to an inquiry via the network N. Furthermore, the area management server 620 may derive prediction information on the congestion state at the time of the entry to the event venue 40 from the number of people with a schedule of entry to the event venue 40 and provide the prediction information. Furthermore, the area management server 620 may derive the prediction information on the congestion state on the basis of the ratio between the number of people who have already entered the event venue and the number of people before entry among the people with a schedule of entry. In a case where the number of people with a schedule of entry is 1000 and the number of people who have entered the event venue at the present time is 100, for example, it is possible to state that the number of people before entry is 900. Therefore, since there is a possibility of 900 people coming to the entrance gate from now, the area management server 620 derives prediction information on a congestion state in a time zone from the current point to the event start time as 900 people. Furthermore, the area management server 620 may collect and provide congestion states of roads, sidewalks, the nearest station 610, and the like inside an area 4. Note that since known information processing apparatuses can be used as management terminals 61 to 6n and 600 and the area management server 620, illustration and detailed description will be omitted.

Here, the privilege information issuing system 1000 includes the user terminal 100, an authentication apparatus 200, a privilege information issuing apparatus 300, an entry control terminal 401, payment terminals 51 to 5n, the management terminals 61 to 6n and 600, and the area management server 620. Each of the user terminal 100, the authentication apparatus 200, the privilege information issuing apparatus 300, the entry control terminal 401, the payment terminals 51 to 5n, the management terminals 61 to 6n and 600, and the area management server 620 is communicatively connected via the network N. Here, the network N is a communication network including a wireless communication line and is, for example, the Internet, a wireless communication line network, a mobile phone line network, or the like. The network N may be of any type of communication protocol.

The authentication apparatus 200 is an information processing apparatus that manages face feature information of the user and performs face authentication. In response to a face authentication request received from the outside, the authentication apparatus 200 collates a face image or face feature information included in the request with the face feature information of each user, and returns the collation result (authentication result) to the request source.

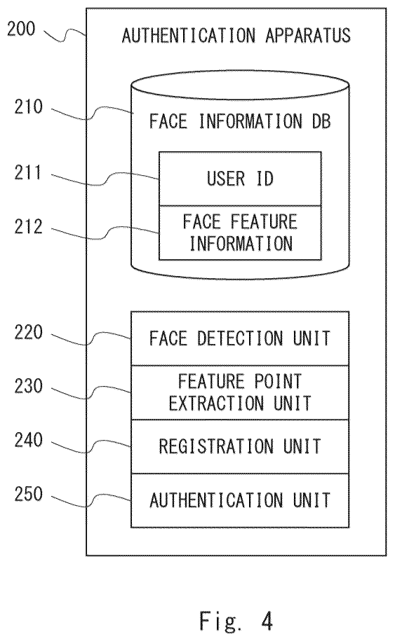

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB 210 in response to a request from the user or the like corresponding to the face feature information 212. Alternatively, the authentication apparatus 200 may delete the face feature information 212 after elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the privilege information issuing apparatus 300 or the like, and outputs the face feature information to the authentication unit 250.

The registration unit 240 newly issues the user ID 211 at a time of registering the face feature information. The registration unit 240 registers the issued user ID 211 and the face feature information 212 extracted from the registered image in the face information DB 210 in association with each other. The authentication unit 250 performs face authentication using the face feature information 212. Specifically, the authentication unit 250 collates the face feature information extracted from the face image with the face feature information 212 in the face information DB 210. If the collation is successful, the authentication unit 250 specifies the user ID 211 associated with the collated face feature information 212. The authentication unit 250 returns the matching result of the face feature information to the request source as a face authentication result. Whether or not the pieces of face feature information match each other corresponds to whether or not authentication has been successful or failed. Note that the fact that the pieces of face feature information match each other refers to the case where the degree of matching is equal to or greater than a threshold value. In addition, it is assumed that the face authentication result includes the specified user ID if the face authentication has been successful.

Returning to FIG. 3, the description will be continued. The user U1 carries the user terminal 100 with himself/herself, operates the user terminal 100, is a purchaser of entry qualification information for an event that is held in the event venue 40, and is a person with a schedule of entry. Here, the “entry qualification information” is information proving that the user can enter the event venue through identity authentication.

The user terminal 100 is an information processing terminal that registers user information including the face image and the entry qualification information in the privilege information issuing apparatus 300 in advance in accordance with an operation of the user U1. Note that the user U1 may perform registration and the like of the user information using an information processing apparatus other than the user terminal 100. Furthermore, it is assumed that the user U1 enters the event venue 40 with the user terminal 100 carried with the user.

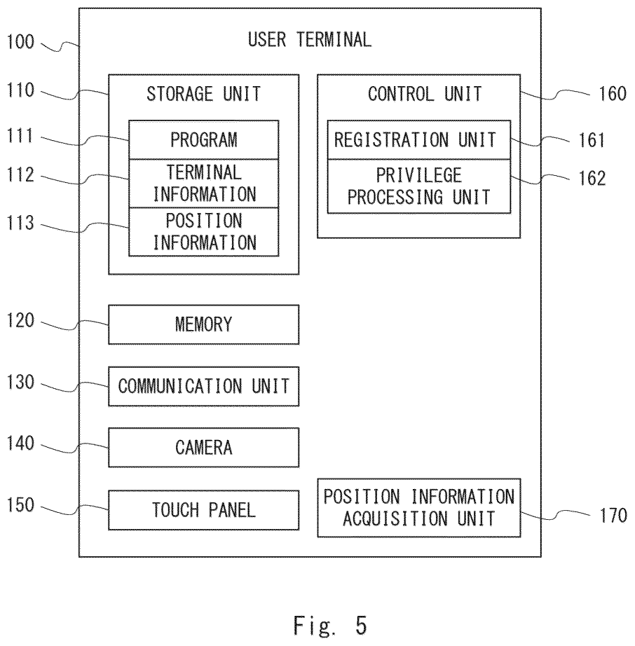

FIG. 5 is a block diagram illustrating a configuration of the user terminal 100 according to the second example embodiment. The user terminal 100 includes a storage unit 110, a memory 120, a communication unit 130, a camera 140, a touch panel 150, a control unit 160, and a position information acquisition unit 170. The storage unit 110 is an example of a nonvolatile storage device such as a flash memory. The storage unit 110 stores a program 111, terminal information 112, and position information 113. The program 111 is a computer program in which processing such as registration of user information and entry qualification information, and inquiry, display, selection, and utilization of privilege information are mounted. The terminal information 112 is identification information and destination information of the user terminal 100. The position information 113 is information indicating the position where the user terminal 100 is present. Although the position information 113 is, for example, global positioning system (GPS) information, the position information 113 is not limited thereto.

The memory 120 is a volatile storage device such as a random access memory (RAM) and is a storage region for temporarily holding information during an operation of the control unit 160. The communication unit 130 is a communication interface with the network N.

The camera 140 is an imaging apparatus for imaging a region including the face of the user U1. The camera 140 outputs the captured image to the control unit 160. The touch panel 150 includes a display apparatus (display unit) such as a screen and an input apparatus. The position information acquisition unit 170 periodically acquires GPS information from a GPS satellite or the like and saves the GPS information as the position information 113 in the storage unit 110.

The control unit 160 is a processor, that is, a control apparatus, that controls each configuration of the user terminal 100. The control unit 160 reads the program 111 from the storage unit 110 into the memory 120 and executes the program 111. In this manner, the control unit 160 implements the functions of the registration unit 161 and the privilege processing unit 162.

The registration unit 161 controls the camera 140, images the face of the user U1, and acquires the captured face image. Also, the registration unit 161 acquires attribute information and payment information input by the user U1 via the touch panel 150. In addition, the registration unit 161 reads and acquires the terminal information 112 from the storage unit 110. Then, the registration unit 161 transmits a registration request of the user information (member information) including the face image, the terminal information 112, the attribute information, and the payment information to the privilege information issuing apparatus 300. Furthermore, the registration unit 161 acquires entry qualification information purchased by the user U1. The registration unit 161 transmits a registration request including the face image of the user U1 and the entry qualification information to the privilege information issuing apparatus 300. Note that the registration unit 161 may include the entry qualification information in the registration request of the user information.

In response to a privilege issuing request provided through an instruction from the user U1 via the touch panel 150, the privilege processing unit 162 controls the camera 140, images the face of the user U1, and acquires the captured face image. At this time, the privilege processing unit 162 reads and acquires the terminal information 112 and the position information 113 (current position) from the storage unit 110. Then, the privilege processing unit 162 transmits a privilege issuing request including the face image, the terminal information 112, and the position information 113 to the privilege information issuing apparatus 300. Also, in a case where the privilege processing unit 162 receives a notification of privilege information issued from the privilege information issuing apparatus 300, the privilege processing unit 162 displays the privilege information and the like provided through the notification on the touch panel 150. In addition, the privilege processing unit 162 transmits a privilege information inquiry request including the face image of the user U1 to the privilege information issuing apparatus 300 in response to the privilege inquiry request provided through an instruction from the user U1 via the touch panel 150. Then, the privilege processing unit 162 displays, on the touch panel 150, a list of the privilege information that has already been issued from the privilege information issuing apparatus 300 for the user U1. The privilege processing unit 162 displays the privilege information selected by the user U1 via the touch panel 150 in a selected state. In a case where the privilege processing unit 162 receives a privilege information update notification from the privilege information issuing apparatus 300, the privilege processing unit 162 displays the privilege information after update on the touch panel 150. Note that the issuing and inquiry of the privilege information may be performed through other identity authentication instead of the face authentication. For example, the privilege processing unit 162 may include biometric information other than the face image, a login ID and a password for a privilege information management application, a user ID for a service related to the privilege information, or the like in the privilege information issuing request or the privilege information inquiry request. In that case, it is only necessary for the privilege information issuing apparatus 300 to perform identity authentication in accordance with information included in the request, for example, biometric authentication or ID authentication, and to perform issuing or inquiry of the privilege information if the authentication has been successful.

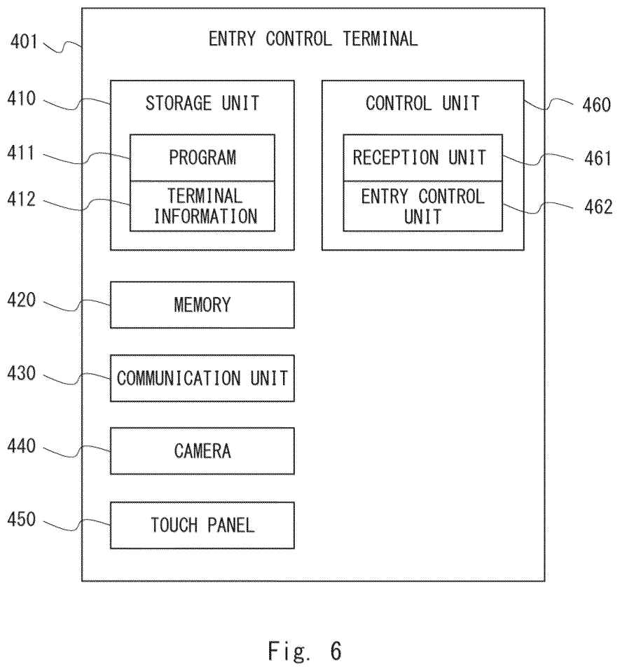

FIG. 6 is a block diagram illustrating a configuration of the entry control terminal 401 according to the second example embodiment. The entry control terminal 401 includes a storage unit 410, a memory 420, a communication unit 430, a camera 440, a touch panel 450, and a control unit 460. The storage unit 410 is an example of a nonvolatile storage device such as a flash memory. The storage unit 410 stores a program 411 and terminal information 412. The program 411 is a computer program in which the entry control processing and the like are mounted. The terminal information 412 is identification information and destination information of the entry control terminal 401.

The memory 420 is a volatile storage device such as a RAM, and is a storage region for temporarily holding information during operations of the control unit 460. The communication unit 430 is a communication interface with the network N.

The camera 440 is an imaging apparatus for imaging a region including a face of an entry scheduled person such as the user U1. The camera 440 outputs the captured image to the control unit 460. The touch panel 450 includes a display apparatus (display unit) such as a screen and an input apparatus.

The control unit 460 is a processor, that is, a control apparatus that controls each configuration of the entry control terminal 401. The control unit 460 reads the program 411 from the storage unit 410 into the memory 420 and executes the program 411. In this manner, the control unit 460 implements the functions of the reception unit 461 and the entry control unit 462.

The reception unit 461 receives the face image of the entry scheduled person captured by the camera 440 and outputs the face image to the entry control unit 462. The entry control unit 462 transmits an entry determination request including the face image output by the reception unit 461 and the terminal information 412 stored in the storage unit 110 to the privilege information issuing apparatus 300. Then, in a case where the entry control unit 462 receives an entry determination result from the privilege information issuing apparatus 300 and the entry determination result indicates permission of entry, the entry control unit 462 performs control to unlock an entrance gate (not illustrated) or the like of the event venue 40. Note that entry control terminal 401 may control an exit gate through face authentication at the time of exiting the site as well.

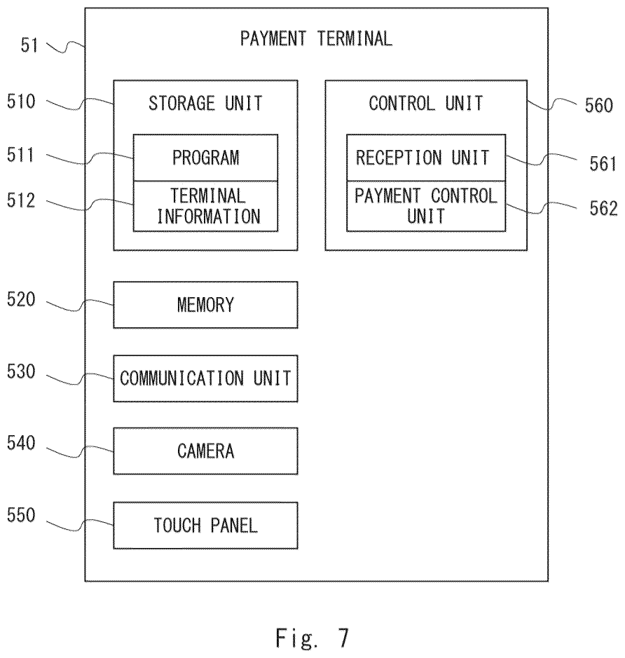

FIG. 7 is a block diagram illustrating a configuration of the payment terminal 51 according to the second example embodiment. Note that since the configurations of the payment terminal 5n and the like are similar to that of the payment terminal 51, illustration and detailed description will be omitted. The payment terminal 51 includes a storage unit 510, a memory 520, a communication unit 530, a camera 540, a touch panel 550, and a control unit 560. The storage unit 510 is an example of a nonvolatile storage device such as a flash memory. The storage unit 510 stores a program 511 and terminal information 512. The program 511 is a computer program in which payment control processing and the like are mounted. The terminal information 512 is identification information and destination information of the payment terminal 51. In addition, the terminal information 512 is assumed to be information with which the commercial facility 41 where the terminal is installed can be specified.

The memory 520 is a volatile storage device such as a RAM, and is a storage region for temporarily holding information during the operations of the control unit 560. The communication unit 530 is a communication interface with the network N.

The camera 540 is an imaging apparatus for imaging a region including a face of a person who makes payment such as the user U1. The camera 540 outputs the captured image to the control unit 560. The touch panel 550 includes a display apparatus (display unit) such as a screen and an input apparatus.

The control unit 560 is a processor, that is, a control apparatus that controls each configuration of the payment terminal 51. The control unit 560 reads the program 511 from the storage unit 510 into the memory 520 and executes the program 511. In this manner, the control unit 560 implements the functions of the reception unit 561 and the payment control unit 562.

The reception unit 561 receives an input of payment target information such as a price of a product for the person who makes payment will make a payment for. For example, the reception unit 561 receives, as payment target information, information read from a barcode on a product with a scanner (not illustrated) by a store staff (for example, the facility staff U21 or the like) of the commercial facility 41. Then, the reception unit 561 displays the received payment target information on the touch panel 550.

The payment control unit 562 reads code information of the privilege information displayed on the user terminal 100 from the image captured by the camera 540, analyzes the image, and extracts the privilege ID. Then, the payment control unit 562 controls the camera 540, images the face of the person who makes payment, and acquires the captured face image. Then, the payment control unit 562 transmits a face authentication payment request including the face image, payment target information, the privilege ID, and the terminal information 512 stored in the storage unit 510 to the privilege information issuing apparatus 300. Then, the payment control unit 562 receives a payment completion notification or the like, and displays the payment completion notification or the like on the touch panel 550.

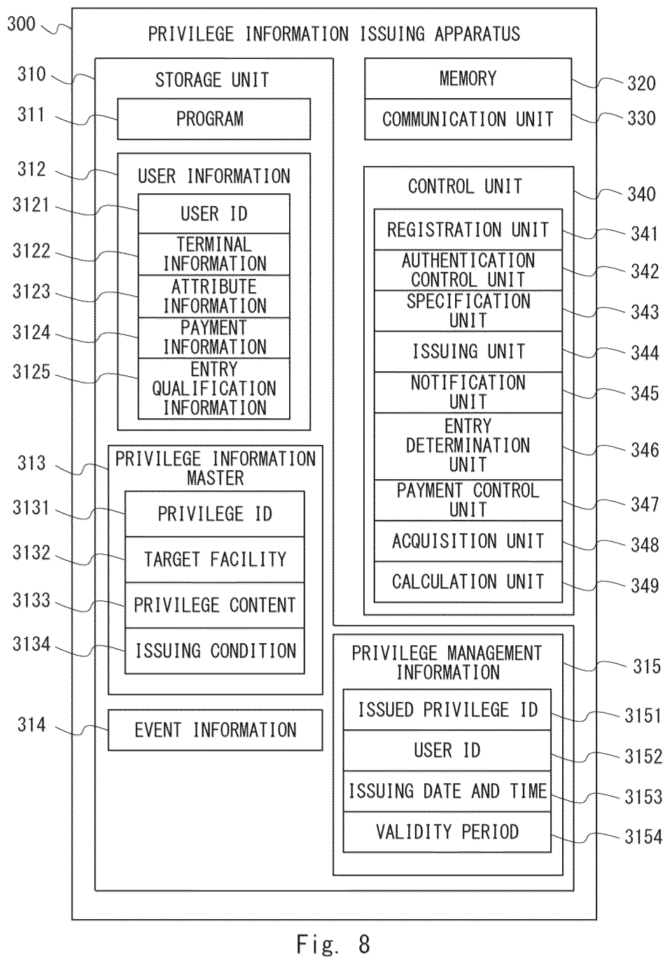

FIG. 8 is a block diagram illustrating a configuration of the privilege information issuing apparatus 300 according to the second example embodiment. The privilege information issuing apparatus 300 is an example of the aforementioned privilege information issuing apparatus 1. The privilege information issuing apparatus 300 is an information processing apparatus for assisting sending of customers to the commercial facility 41 and the like in the surroundings of the event venue 40 before the event held in the event venue 40 is started. The privilege information issuing apparatus 300 may be made redundant across a plurality of serves, and each functional block may be implemented by a plurality of computers.

The privilege information issuing apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, user information 312, a privilege information master 313, event information 314, and privilege management information 315. Note that the storage unit 310 and the face information DB 210 of the authentication apparatus 200 may be collectively regarded as a storage apparatus that stores the entry qualification information, the identity authentication information of the person with the schedule of entry who has purchased the entry qualification information, and the terminal that the person with the schedule of entry carries with himself/herself in an associated manner. The program 311 is a computer program (privilege information issuing program) in which processing of registering the privilege information, the user information, and the entry qualification information, the privilege information issuing processing, the payment processing including the privilege information utilization processing, and the like according to the second example embodiment are implemented.

The user information 312 is information for managing users in the area 4. Note that “users in area 4” are, for example, purchasers of the entry qualification information of the event venue 40, entry scheduled persons who are scheduled to enter the event venue 40, entering persons, and persons exiting the event venue 40. The user information 312 is information in which a user ID 3121, terminal information 3122, attribute information 3123, payment information 3124, and entry qualification information 3125 are associated.

The user ID 3121 is identification information of the user. The user ID 3121 is information that is the same as or uniquely corresponds to the user ID 211 managed in association with the face feature information 212 in the face information DB 210 of the authentication apparatus 200. Therefore, it is possible to state that the user information 312 is information associated with the identity authentication information for registration of the user via the user ID 3121. The terminal information 3122 is information corresponding to the terminal information 112 of the user terminal 100 described above.

Examples of the attribute information 3123 include, but are not limited to, a name, a date of birth, a sex, an address, a contact (a telephone number, an e-mail address, account information of a social networking service (SNS)), a member rank, information indicating a hobby, preference, or interest, a support target of an athlete or a team, and the like. Note that the member rank may be, for example, information indicating a rank or the like in members who have made payment in the event venue 40, a rank in another member service, or the like.

The payment information 3124 is credit card information, electronic money, barcode payment account information, bank withdrawal account information, or the like, and is also information used for payment using face authentication (face authentication payment).

The entry qualification information 3125 is paid digital entry ticket information for a predetermined event held in the event venue 40 on a date and time of the event. The entry qualification information 3125 may include, for example, an event ID, seat information (a seat position and a seat grade), a ticket price, and the like. Furthermore, the entry qualification information 3125 may include identification information of the event venue, an entry time zone, an event content, and the like, instead of the event ID. Also, it is possible to state that the entry qualification information 3125 according to the present example embodiment is proof information indicating that the user has the qualification of permission to enter the event venue 40 on the basis of success in the face authentication.

The privilege information master 313 is information for managing master information of the privilege information input by facility staff or the area staff. The privilege information master 313 is information in which a privilege ID 3131, a target facility 3132, a privilege content 3133, and an issuing condition 3134 are associated. The privilege ID 3131 is identification information of privilege information. The target facility 3132 is information indicating a facility where the privilege information can be used. The target facility 3132 is, for example, information indicating any of the commercial facilities 41 to 4n. Note that the target facility 3132 may be targeted to two or more facilities among the commercial facilities 41 to 4n.

The privilege content 3133 is information indicating a product or a service that the user can enjoy by being used in the facility. Examples of the privilege content 3133 include, but are not limited to, discount information indicating a discount price or a discount rate, a discount target product or service, a free product or service, and the like.

The issuing condition 3134 is information indicating a condition for issuing the privilege information. Examples of the issuing condition 3134 include event information (an event ID, date and time, and the like) to be issued, the fact that entry qualification information of the event information has already been purchased, and an issuing timing. The issuing timing is an issuing start date and time, a period during which issuing is possible, a scheduled arrival time or arrival time of the person with the schedule of entry, or the like. In addition, examples of the issuing condition 3134 include, but are not limited to, attribute information of the user as a target of issuing, a seat grade, a ticket price, a priority order of attribute information prioritizing issuance, and the like.

The event information 314 is information defining an event held at the event venue 40. The event information 314 includes, for example, an event ID, a venue, event hour information, event contents, seat information (a seat type, a seat number, and arrangement), a price of the entry qualification information (ticket price), and the like. Note that examples of the event hour information include, but are not limited to, an event period, a start date and time, a scheduled start time, a scheduled end time, an entry time zone, an entry start time, and the like.

The privilege management information 315 is information for managing the privilege information issued for the user. The privilege management information 315 is information in which an issued privilege ID 3151, a user ID 3152, an issuing date and time 3153, and a validity period 3154 are associated.

The issued privilege ID 3151 is the privilege ID 3131 issued for the user corresponding to the user ID 3152. The user ID 3152 is the user ID 3121 for which the privilege information has been issued. Therefore, the privilege management information 315 is, for example, information uniquely specified by a set of the issued privilege ID 3151 and the user ID 3152. The issuing date and time 3153 is a date and time on which the privilege information has been issued. The validity period 3154 is a period in which the privilege according to the privilege information can be enjoyed (the privilege information is valid). The validity period 3154 is defined by a start date and time and an end date and time (effective period). In a case where the corresponding privilege information can be used immediately after the issuing, a date and time of the effective period may be set as the validity period 3154.

The memory 320 is a volatile storage device such as a RAM, and is a storage region for temporarily holding information during the operations of the control unit 340. The communication unit 330 is a communication interface with the network N.

The control unit 340 is a processor, that is, a control apparatus that controls each configuration of the privilege information issuing apparatus 300. The control unit 340 reads the program 311 from the storage unit 310 into the memory 320 and executes the program 311. In this manner, the control unit 340 implements the functions of a registration unit 341, an authentication control unit 342, a specification unit 343, an issuing unit 344, a notification unit 345, an entry determination unit 346, a payment control unit 347, an acquisition unit 348, and a calculation unit 349. Note that the acquisition unit 348 is an example of the acquisition unit 11 described above. Also, the calculation unit 349 is an example of the calculation unit 12 described above. In addition, the authentication control unit 342, the specification unit 343, and the issuing unit 344 are examples of the issuing unit 13 described above. Also, the specification unit 343 and the notification unit 345 are examples of the notification unit 14 described above.

The registration unit 341 performs registration processing and the like of the privilege information, the user information, and the entry qualification information. Specifically, the registration unit 341 receives a registration request of individual privilege information from the management terminal 61 or the like and registers the privilege information in the privilege information master 313. At this time, the registration unit 341 issues a privilege ID for the new privilege information. Furthermore, the registration unit 341 receives a registration request of the user information from the user terminal 100 or the like, and registers the registration request in the user information 312. At this time, the registration unit 341 registers face feature information based on a face image for a new user in the authentication apparatus 200, and acquires a user ID issued at the time of the registration. Then, the registration unit 341 registers the acquired user ID 3121 and the information included in the registration request in an associated manner as the user information 312 in the storage unit 310. The registration unit 341 registers, in the storage unit 310, identity authentication information for registration of the user and terminal information possessed by the user in association with each other. The registration unit 341 according to the present example embodiment registers, in the storage unit 310, the user ID 3121 uniquely corresponding to the face feature information for registration of the user, the terminal information 3122, the attribute information 3123, and the payment information 3124 as the user information 312. Furthermore, the registration unit 341 receives a registration request including the face image and the entry qualification information, associates the entry qualification information 3125 with the user information 312 specified by the face authentication based on the face image, and updates the user information 312.

The authentication control unit 342 controls identity authentication of the user using the authentication apparatus 200. In particular, the authentication control unit 342 according to the present example embodiment controls biometric authentication of the user using biometric information extracted from an image obtained by imaging the user. Specifically, the authentication control unit 342 controls the face authentication of the user using the face feature information extracted from the face image of the user. In other words, in a case where the authentication control unit 342 receives the identity authentication information for authentication of the user and the entry qualification information, the authentication control unit controls the identity authentication with reference to the storage unit 310 and the face information DB 210 of the authentication apparatus 200 using the identity authentication information for authentication. In addition, in a case where the authentication control unit 342 receives a privilege issuing request including the face image or a privilege information inquiry request from the user terminal 100, the authentication control unit 342 transmits a face authentication request including the face image included in the request to the authentication apparatus 200 and receives a face authentication result from the authentication apparatus 200. Then, the authentication control unit 342 outputs the face authentication result to the specification unit 343 and the issuing unit 344. Also, in a case where the authentication control unit 342 receives an entry determination request from the entry control terminal 401, the authentication control unit 342 transmits a face authentication request including the face image included in the entry determination request to the authentication apparatus 200, receives a face authentication result from the authentication apparatus 200, and outputs the face authentication result to the entry determination unit 346. Also, in a case where the authentication control unit 342 receives a face authentication payment request from the payment terminal 51 or the like, the authentication control unit 342 transmits a face authentication request including the face image included in the face authentication payment request to the authentication apparatus 200, receives a face authentication result from the authentication apparatus 200, and outputs the face authentication result to the payment control unit 347. Note that the authentication control unit 342 may control the identity authentication other than the biometric authentication.

The specification unit 343 specifies the terminal information, the attribute information, the payment information, the entry qualification information, and the privilege information of the user on the basis of the identity authentication for the user. Specifically, in a case where the face authentication by the authentication control unit 342 is successful, the specification unit 343 specifies the terminal information 3122, the attribute information 3123, the payment information 3124, and the entry qualification information 3125 associated with the user ID 3121 of the user who has succeeded in the face authentication from the user information 312. Moreover, the specification unit 343 may specify the clock time that is attributable to the start of the event from the entry qualification information 3125. For example, the specification unit 343 may specify an available time zone for entry to the event venue included in the entry qualification information 3125. In addition, the specification unit 343 specifies a list of privilege information associated with the user ID 3152 of the user who has succeeded in the face authentication from the privilege management information 315 in response to a privilege information inquiry request. Furthermore, the specification unit 343 specifies the issued privilege ID 3151 included in the face authentication payment request, and specifies the privilege information associated with the user ID 3152 of the user who has succeeded in the face authentication and the issued privilege ID 3151 from the privilege management information 315.

The acquisition unit 348 acquires the entry qualification information associated with the person with the schedule of entry who has succeeded in the identity authentication. Specifically, the acquisition unit 348 determines whether or not there is entry qualification information 3125 associated with the user ID 3121 of the user who has succeeded in the face authentication from the user information 312, and in a case where there is such entry qualification information 3125, the acquisition unit 348 acquires the entry qualification information 3125. In addition, the acquisition unit 348 acquires congestion states of the plurality of commercial facilities in the time zone of the extra time. Specifically, the acquisition unit 348 transmits a congestion state acquisition request designating an area and a time zone to the area management server 620 and acquires the congestion state of each commercial facility from the area management server 620. The “congestion state” is, for example, a numerical value indicating a degree of congestion of customers in a certain restaurant (commercial facility), whether or not all seats are occupied, a ratio of users occupying capacity such as seats (a used seat rate, an unoccupied seat rate), a waiting time until entry to the store or provision of a service, or the like. The acquisition unit 348 further acquires the current position of the person with the schedule of entry who has arrived in the predetermined region. Specifically, the acquisition unit 348 acquires the current position (position information 113) of the user terminal 100 from the privilege issuing request received from the user terminal 100. In addition, the acquisition unit 348 acquires the clock time at which the privilege issuing request has been received as an arrival time of the person with the schedule of entry.

The calculation unit 349 calculates an extra time until a clock time that is attributable to the start of the event from the clock time at which the person with the schedule of entry has arrived in the area 4 on the basis of the entry qualification information 3125. For example, the calculation unit 349 calculates a time from the arrival time to the entry available time zone. Since the entry available time zone is a time zone between the entry start time and the entry end time, it is only necessary for the calculation unit 349 to calculate a time from the arrival time to the entry start time and a time from the arrival time to the entry end time. Note that the extra time is not limited to the time from the arrival time to the entry available time zone and may be a time from the arrival time to the start time of the event (a concert or a sport game, for example).

In addition, the calculation unit 349 calculates the first required travel time from a travel start point of the person with the schedule of entry to the commercial facility. Specifically, the calculation unit 349 calculates, as the first required travel time, a time required for traveling through a route from the current position of the user U1 to each commercial facility. In addition, the calculation unit 349 calculates an expected staying time at each commercial facility. In particular, the calculation unit 349 calculates the expected staying time at each commercial facility on the basis of the congestion state. Furthermore, the calculation unit 349 may calculate a second required travel time from each commercial facility to the event venue 40. Note that a time calculated in advance may be used as the second required travel time from each commercial facility to the event venue 40. Furthermore, the calculation unit 349 may calculate the first and second required travel times on the basis of congestion states in roads, sidewalks, a nearest station 610, and the like. In addition, the calculation unit 349 calculates a required total time by summing the first required travel time, the expected staying time, and the second required travel time.

The issuing unit 344 issues privilege information for the user U1 who has succeeded face authentication in response to the privilege issuing request and has entry qualification information registered. In particular, the issuing unit 344 issues the privilege information that can be used in one or more commercial facilities in the neighborhood of the event venue on the basis of the extra time. Furthermore, the issuing unit 344 selects a commercial facility as a target of issuing of the privilege information from among the plurality of commercial facilities in the neighborhood of the event venue on the basis of the extra time and issues privilege information that can be used in the selected commercial facility. Furthermore, it is only necessary for the issuing unit 344 to select the commercial facility as the target of issuing of the privilege information from among the plurality of commercial facilities on the basis of a relationship between the required total time and the extra time. Specifically, the issuing unit 344 selects a commercial facility in which the required total time is within the extra time as the target of issuing of the privilege information. In other words, the issuing unit 344 selects a commercial facility, the required total time of which meets the extra time.

Also, it is only necessary for the issuing unit 344 to select the commercial facility as the target of issuing of the privilege information from among the plurality of commercial facilities on the basis of the congestion state as well. Also, it is only necessary for the issuing unit 344 to select the commercial facility as the target of issuing of the privilege information from among the plurality of commercial facilities in the neighborhood of the event venue on the basis of the current position as well. Moreover, the issuing unit 344 issues the privilege information that can be used in the selected commercial facility for the user U1 who has succeeded in the face authentication.

The notification unit 345 notifies the user terminal 100 of the user U1 of the privilege information issued by the issuing unit 344. For example, in a case where face authentication in response to the privilege issuing request has been successful, the entry qualification information has been acquired, and the privilege information has been issued, the notification unit 345 specifies the terminal information 3122 associated with the user ID 3121. Then, the notification unit 345 notifies the user terminal 100 regarded as a destination from the specified terminal information 3122 of the privilege information.

The entry determination unit 346 determines whether or not the face authentication result based on the entry determination request received from the entry control terminal 401 indicates that the face authentication has been successful, and transmits the entry determination result to the entry control terminal 401. The entry determination unit 346 includes an indication of permission of entry in the entry determination result in a case of the user who has succeeded in the face authentication and has entry qualification information registered, or the entry determination unit 346 includes an indication of non-permission of entry in the entry determination result in a case where the user has failed the face authentication. Note that, in a case where the face authentication has been successful, the entry determination unit 346 may perform registration in the user information 312 such that completion of entry of the user who has succeeded in the face authentication can be identified. For example, the entry determination unit 346 may register an entry state flag indicating “completion of entry” or the date and time of entry in the entry qualification information 3125 associated with the user ID 3121 of the user who has succeeded in the face authentication. Note that the entry determination unit 346 may update the entry state flag to “completion of exiting” in a case where exiting of the user is detected through face authentication or the like.

The payment control unit 347 determines whether or not a face authentication result based on a face authentication payment request received from the payment terminal 51 or the like has been successful, and in a case where the face authentication has been successful, the payment control unit 347 specifies the user ID of the user who has succeeded in the face authentication and controls the payment processing. In particular, in a case where the privilege ID is included in the face authentication payment request, the payment control unit 347 determines whether or not the privilege information corresponding to the privilege ID can be used, and in a case where the privilege information can be used, the payment control unit 347 performs payment processing using the privilege information. Specifically, the payment control unit 347 specifies the facility from the terminal information included in the received face authentication payment request and specifies the target facility 3132 associated with the privilege ID (the issued privilege ID 3151, the privilege ID 3131) included in the face authentication payment request. In a case where the specified facility is included in the target facility 3132, the payment control unit 347 determines that the privilege information can be used. Furthermore, in a case where the utilization state flag and the like are included in the privilege management information 315, the payment control unit 347 may determine the availability in consideration of the utilization state flag and the like.

Then, in a case where the privilege information can be used, the payment control unit 347 specifies the payment information 3124 associated with the specified user ID 3121 from the user information 312. Then, the payment control unit 347 specifies the issued privilege ID 3151 associated with the specified user ID 3152 from the privilege management information 315 and specifies the privilege content 3133 associated with the issued privilege ID 3151 as the privilege ID 3131 from the privilege information master 313. Then, the payment control unit 347 applies the specified privilege content 3133 to the price of the payment target information included in the face authentication payment request and calculates a payment price. In a case where the privilege content 3133 is “lunch set 10% off”, for example, the payment control unit 347 calculates a price obtained by discounting 10% from the price of the payment target information as the payment price. Then, the payment control unit 347 transmits an instruction for withdrawing the payment price to a payment server (not illustrated) using the specified payment information 3124 and receives a payment result. Note that the payment server is a known server operated by a financial institution or the like and illustration and detailed description thereof will thus be omitted. Also, in a case where the privilege content 3133 is “one drink for free” and a drink is included in the payment target information, the payment control unit 347 subtracts the price of one glass of drink from the price of the payment target information and calculates the payment price.

On the other hand, in a case where the privilege information cannot be used, the payment control unit 347 performs the payment processing without using the privilege information. In other words, the payment control unit 347 performs the payment processing for the payment target information using the payment information of the specified user ID.

Here, a flow of registration of the privilege information will be described. Here, an example in which the facility staff U21 registers privilege information of the commercial facility 41 will be described. First, the management terminal 61 receives inputs of privilege content that can be used in the commercial facility 41, an issuing condition, and a target facility from the facility staff U21. The issuing conditions include event information that is a target of issuing. The target facility is the commercial facility 41. Then, the management terminal 61 transmits a privilege information master registration request including the received privilege content, issuing condition, and target facility to the privilege information issuing apparatus 300 via the network N. In response to the request, the privilege information issuing apparatus 300 issues the privilege ID corresponding to the privilege content included in the received privilege information master registration request and registers the issued privilege ID 3131, the target facility 3132 included in the request, the privilege content 3133, and the issuing condition 3134 in an associated manner as the privilege information master 313 in the storage unit 310. Similarly, the facility staff U2n registers privilege information related to the commercial facility 4n. Note that the area staff U3 may register the privilege information of the commercial facility 41 and the like using the management terminal 600. In addition, the facility staff U21 to U2n, the area staff U3, and the like may update the privilege content, the issuing conditions, and the target facilities in the privilege information that has already been registered.

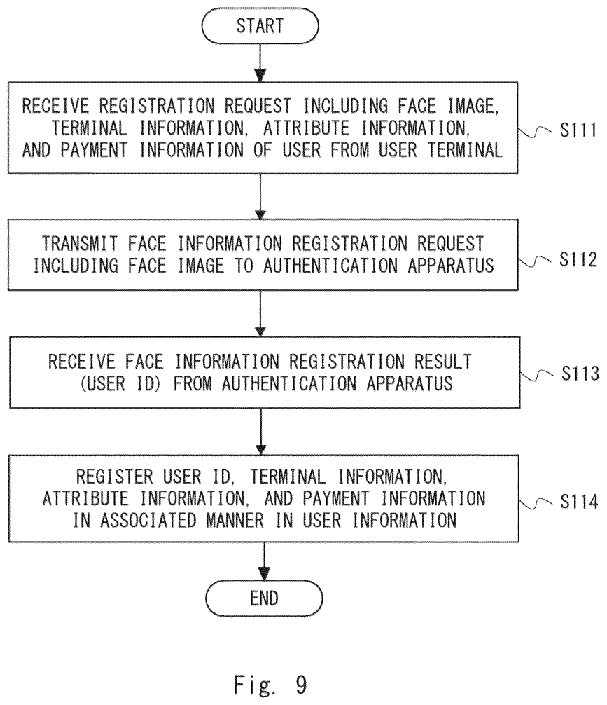

FIG. 9 is a flowchart illustrating a flow of member information registration processing according to the second example embodiment. First, the privilege information issuing apparatus 300 receives a registration request including a face image, terminal information, attribute information, and payment information of the user U1 from the user terminal 100 via the network N (S111). Then, the privilege information issuing apparatus 300 transmits a face information registration request including the face image to the authentication apparatus 200 via the network N (S112). In response to the transmission, the authentication apparatus 200 performs face information registration processing.

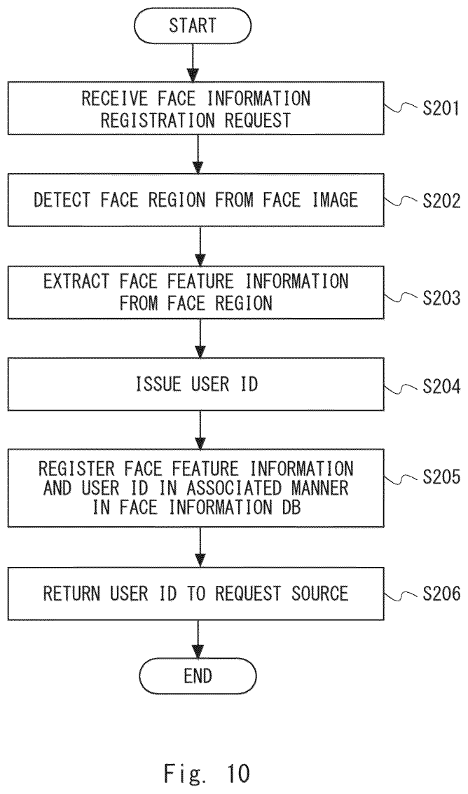

FIG. 10 is a flowchart illustrating a flow of face information registration processing performed by the authentication apparatus according to the second example embodiment. First, the authentication apparatus 200 receives the face information registration request (S201). For example, the authentication apparatus 200 receives the face information registration request from the privilege information issuing apparatus 300 via the network N. Then, the face detection unit 220 detects a face region from the face image included in the face information registration request (S202). Then, the feature point extraction unit 230 extracts feature points (face feature information) from the face region detected in Step S202 (S203). Then, the registration unit 240 issues the user ID 211 (S204). Then, the registration unit 240 registers the extracted face feature information 212 and the issued user ID 211 in an associated manner in the face information DB 210 (S205). Thereafter, the registration unit 240 returns the issued user ID 211 to the request source (for example, the privilege information issuing apparatus 300) (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 9, the description will be continued.

The privilege information issuing apparatus 300 receives a face information registration result (user ID) from the authentication apparatus 200 via the network N (S113). Then, the privilege information issuing apparatus 300 registers the received user ID 3121 and the terminal information 3122, the attribute information 3123, and the payment information 3124 received in Step S101 in an associated manner in the user information 312 (S114).

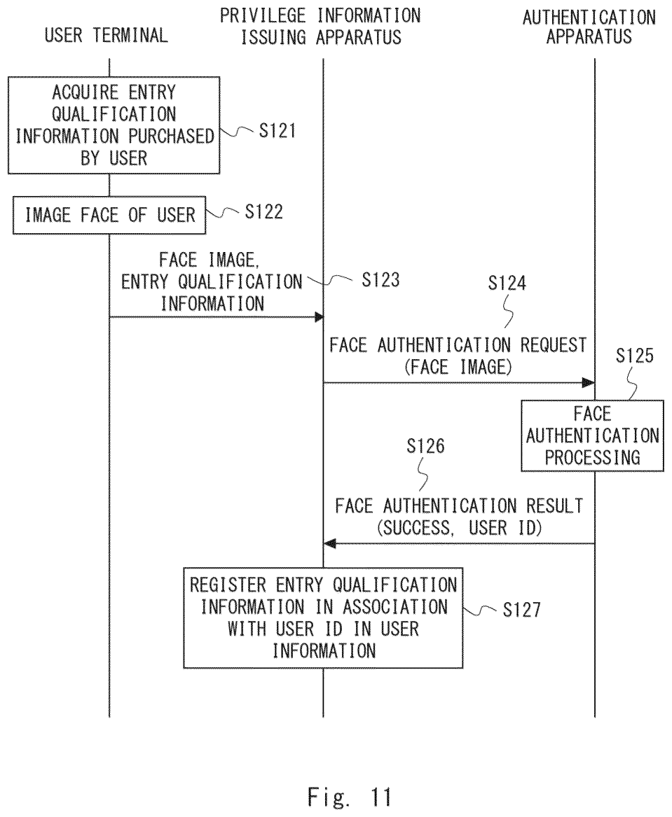

FIG. 11 is a sequence diagram illustrating a flow of entry qualification information registration processing according to the second example embodiment. As a premise, it is assumed that the user U1 has registered the user information in the privilege information issuing apparatus 300 and has purchased entry qualification information of an event held on a predetermined date at the event venue 40. At this time, the user terminal 100 acquires the entry qualification information purchased by the user U1 (S121). For example, the user terminal 100 may receive an input of identification information or the like of the entry qualification information from the user U1. Alternatively, the user terminal 100 may acquire information regarding the entry qualification information provided through a notification from a purchasing site of the entry qualification information. Then, the user terminal 100 images the face of the user U1 (S122). Then, the user terminal 100 transmits a registration request including the face image and the entry qualification information to the privilege information issuing apparatus 300 via the network N (S123).

Then, the privilege information issuing apparatus 300 transmits a face authentication request including the received face image to the authentication apparatus 200 via the network N (S124). In response to the transmission, the authentication apparatus 200 performs face authentication processing (S125).

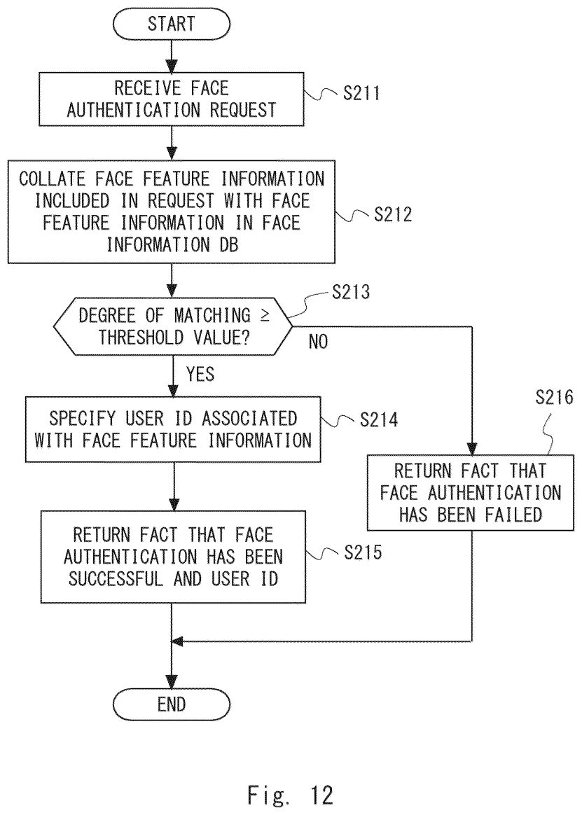

FIG. 12 is a flowchart illustrating a flow of face authentication processing performed by the authentication apparatus according to the second example embodiment. First, the authentication apparatus 200 receives a face authentication request from the privilege information issuing apparatus 300 via the network N (S211). Then, the authentication apparatus 200 extracts face feature information from the face image included in the face authentication request similarly to Steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). In a case where the pieces of face feature information match each other, that is, in a case where the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has been successful and the specified user ID 211, to the privilege information issuing apparatus 300 via the network N (S215). In a case where the degree of matching is less than the threshold value in Step S213, the authentication unit 250 returns the face authentication result including information indicating that the face authentication has been failed to the privilege information issuing apparatus 300 via the network N (S216).

Returning to FIG. 11, the description will be continued.

The privilege information issuing apparatus 300 receives the face authentication result from the authentication apparatus 200 via the network N (S126). Then, the privilege information issuing apparatus 300 determines whether or not the face authentication has been successful. Specifically, the privilege information issuing apparatus 300 refers to the face authentication result and determines that the face authentication has been successful if the face authentication result includes the user ID. Note that in a case where it is determined that the face authentication has been failed, the privilege information issuing apparatus 300 may return the fact that the user has failed the face authentication to the user terminal 100 via the network N.

In a case where the face authentication has been successful, the privilege information issuing apparatus 300 associates the entry qualification information 3125 received in Step S123 with the user ID 3121 included in the face authentication result and registers them in the user information 312 (S127).

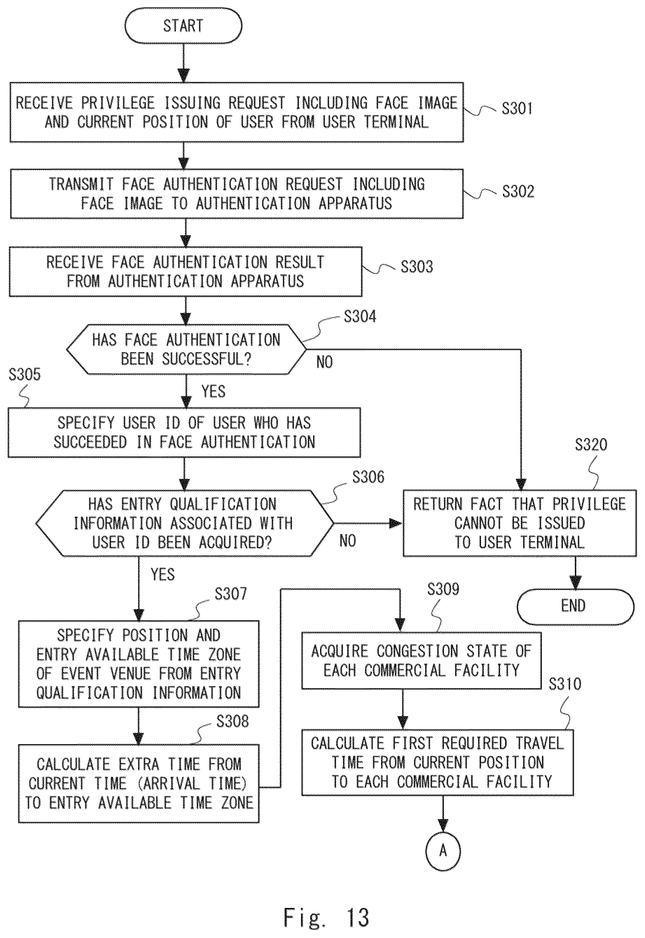

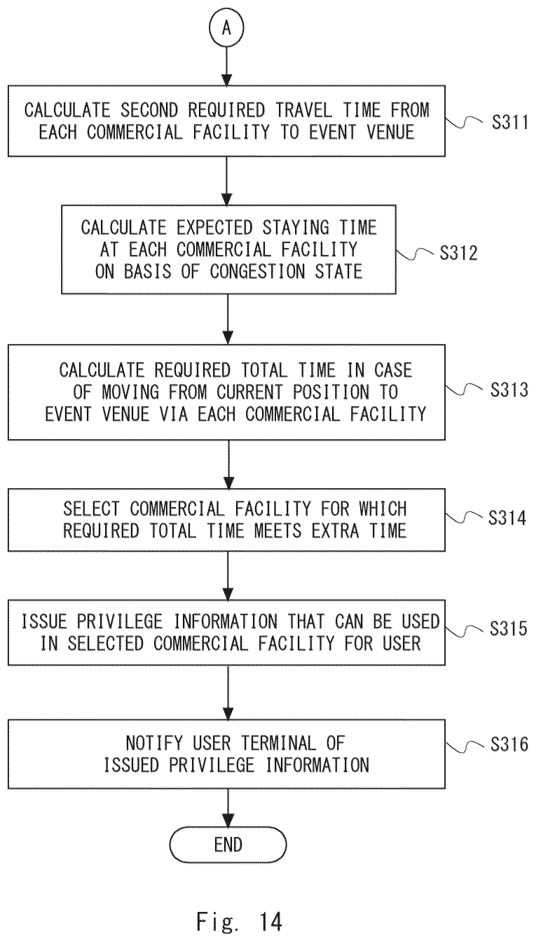

FIGS. 13 and 14 are flowcharts illustrating a flow of privilege information issuing processing according to the second example embodiment. First, the user terminal 100 images the face of the user U1 in response to an instruction of the privilege issuing request from the user U1 and transmits the privilege issuing request including the face image and the current position (the position information 113 of the user terminal 100) to the privilege information issuing apparatus 300 via the network N.

In response to the transmission, the privilege information issuing apparatus 300 receives the privilege issuing request including the face image and the current position of the user from the user terminal 100 via the network N (S301). Then, the privilege information issuing apparatus 300 transmits a face authentication request including the face image to the authentication apparatus 200 via the network N (S302). In response to this, the authentication apparatus 200 performs face authentication processing similarly to FIG. 12 described above. Then, the privilege information issuing apparatus 300 receives a face authentication result from the authentication apparatus 200 (S303). Then, the privilege information issuing apparatus 300 determines whether or not the face authentication has been successful (S304).

In a case where the face authentication has been successful, the privilege information issuing apparatus 300 specifies the user ID of the user who has succeeded in the face authentication (S305). Specifically, the privilege information issuing apparatus 300 acquires the user ID from the received face authentication result. Then, the privilege information issuing apparatus 300 determines whether or not the entry qualification information associated with the specified user ID can be acquired (S306). Specifically, the privilege information issuing apparatus 300 determines whether or not the entry qualification information 3125 is associated with the specified user ID 3121 with reference to the user information 312. In a case where it is determined that the entry qualification information 3125 is associated with the specified user ID 3121, then the privilege information issuing apparatus 300 reads the entry qualification information 3125 associated with the user ID 3121 from the storage unit 310. Then, in a case where the day if the event corresponding to the read entry qualification information 3125 is held is within a predetermined period from the current day, the privilege information issuing apparatus 300 determines that the entry qualification information 3125 can be acquired. In other words, the privilege information issuing apparatus 300 acquires the entry qualification information associated with the user ID of the user who has succeeded in the face authentication in this case.

On the other hand, in a case where the face authentication has failed in Step S304, or in a case where the entry qualification information is not associated in Step S306, or in a case where the event day is not within the predetermined period from the current day, the privilege information issuing apparatus 300 returns the fact that the privilege cannot be issued to the user terminal 100. Then, the privilege information issuing processing is ended.

In a case where the entry qualification information can be acquired in Step S306, the privilege information issuing apparatus 300 specifies the position of the event venue and the entry available time zone from the entry qualification information (S307). For example, the privilege information issuing apparatus 300 specifies an address or position information of the event venue 40 and the available time zone for the entry to the event venue 40 from the event information 314 corresponding to the event ID included in the acquired entry qualification information 3125. Note that the privilege information issuing apparatus 300 may specify the event start time or the start time of entry to the event venue 40 instead of the entry available time zone.

Then, the privilege information issuing apparatus 300 calculates an extra time from the current time (arrival time) to the entry available time zone (S308). For example, it is only necessary for the privilege information issuing apparatus 300 to calculate a first extra time from the arrival time to the entry start time and a second extra time from the arrival time to the entry end time and to calculate a range from the first extra time to the second extra time as the extra time as described above. Note that the privilege information issuing apparatus 300 may calculate any of the first extra time, the second extra time, a third extra time from the arrival time to the event start time, and a fourth extra time from the arrival time to the event end time as the extra time. For example, in a case where the user definitely does not want to be late for the start of the event, the user may set the “first extra time” in advance as the extra time in the privilege information issuing apparatus 300. In this case, the user may set not only the “first extra time” (from the arrival time to the entry start time) but also the “third extra time” (from the arrival time to the event start time) as the extra time. Also, in a case where the user desires to do shopping with the coupon even if the user is slightly late for the start time of the event, it is only necessary for the user to set the “fourth extra time” as the extra time in advance in the privilege information issuing apparatus 300. Furthermore, in this case, the user may set not only the “fourth extra time” (from the arrival time to the event end time) but also the “second extra time” (from the arrival time to the entry end time) as the extra time. At this time, the entry end time in the “second extra time” may be a clock time at which it becomes impossible to enter the event venue after elapse of a predetermined time from the start of the event. Specifically, the entry end time may be a predetermined time before the event end time, for example, 30 minutes after the event start time. Then, it is only necessary for the privilege information issuing apparatus 300 to calculate the extra time set as any of the above extra times and to issue a coupon of the type in accordance with the extra time. Therefore, even if the arrival time or the event start time is the same, the user can flexibly set the extra time in accordance with preference of the user himself/herself and acquire and use a coupon of a type that is different depending on the extra time.

Then, the privilege information issuing apparatus 300 acquires the congestion state of each commercial facility (S309). Specifically, the privilege information issuing apparatus 300 transmits a congestion state acquisition request designating the area 4, the current time, and the entry available time zone to the area management server 620 as described above. Then, the privilege information issuing apparatus 300 acquires prediction information on the current congestion state and the congestion state in the entry available time zone at each commercial facility from the area management server 620.

Then, the privilege information issuing apparatus 300 calculates the first required travel time from the current position to each commercial facility as described above (S310). Then, the privilege information issuing apparatus 300 calculates the second required travel time from each commercial facility to the event venue as descried above (S311). Then, the privilege information issuing apparatus 300 calculates the expected staying time at each commercial facility on the basis of the congestion state as described above (S312). For example, it is only necessary for the privilege information issuing apparatus 300 to sum the waiting time until entry to the store or acceptance of an order and an expected store using time such as a time required to have foods at the store or to receive products to go and to calculate the total as the expected staying time for each of the commercial facilities 41 to 4n. Then, the privilege information issuing apparatus 300 calculates the required total time in a case of traveling from the current position to the event venue via each commercial facility as described above (S313).

Thereafter, the privilege information issuing apparatus 300 selects a commercial facility, the required total time of which meets the extra time (S314). Specifically, the privilege information issuing apparatus 300 determines whether or not the required total time of each of the commercial facilities 41 to 4n calculated in Step S313 is included within the range from the first extra time to the second extra time. In a case where the required total time is included within the range, the privilege information issuing apparatus 300 calculates an inclusion time in which the required total time of each commercial facility is included within the range from the first extra time to the second extra time. Then, the privilege information issuing apparatus 300 selects a commercial facility, the inclusion time of which is equal to or greater than a predetermined time, from among the commercial facilities 41 to 4n as the commercial facility, the required total time of which meets the extra time. Alternatively, the privilege information issuing apparatus 300 may select a predetermined number of commercial facilities with the top inclusion times from among the commercial facilities 41 to 4n.

Then, the privilege information issuing apparatus 300 issues privilege information that can be used in the selected commercial facility for the user (S315). Specifically, the privilege information issuing apparatus 300 specifies the issuing condition 3134 associated with the target facility 3132 including the commercial facility selected in Step S314 from the privilege information master 313. In a case where the event ID defined in the specified issuing condition 3134 corresponds to the entry qualification information 3125 acquired in Step S306, the privilege information issuing apparatus 300 specifies the privilege ID 3131 and the privilege content 3133 associated with the target facility 3132 and the issuing condition 3134. Then, the privilege information issuing apparatus 300 generates privilege management information 315 by associating the privilege ID of the specified privilege information and the user ID specified in Step S305 as the issued privilege ID 3151 and the user ID 3152. Also, the privilege information issuing apparatus 300 sets the current date and time as the issuing date and time 3153 and a period from the current time to the event entry end time as the validity period 3154 in the generated privilege management information 315. The privilege information issuing apparatus 300 registers the generated and set privilege management information 315 in the storage unit 310. Note that the effective period of the validity period 3154 may be an event entry start time instead of the event entry end time. Alternatively, the effective period of the validity period 3154 may be later than the event start time. Alternatively, in a case where re-entry to the event is allowed, the effective period of the validity period 3154 may be re-entry end time.

Thereafter, the privilege information issuing apparatus 300 notifies the user terminal 100 of the user U1 as the target of issuing (with the terminal information 3122 designated as a destination) of the issued privilege information (S316). In response to the notification, the user terminal 100 displays the privilege information provided through the notification.

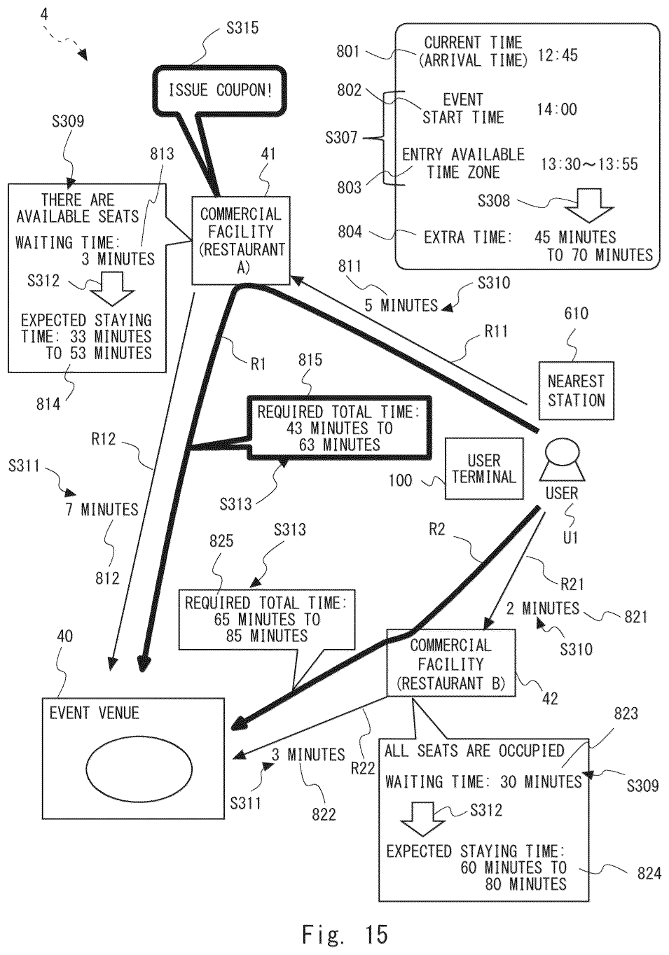

FIG. 15 is a diagram illustrating an example of relationships between positional relationships of the event venue, the commercial facilities in the neighborhood, and the person with the schedule of entry and required times according to the second example embodiment. First, it is assumed that the event venue 40, the commercial facilities 41 (restaurant A) and 42 (restaurant B) in the neighborhood thereof, and the nearest station 610 are present in the area 4. In this example, both the restaurants A and B are seated-style eating places. For example, the restaurant A may be a restaurant or the like, and the restaurant B may be a fast food shop. Also, it is assumed that the restaurant A which is the restaurant located relatively far from the nearest station 610 and the event venue 40 is relatively empty and a waiting time there is short while the restaurant B which is the fast food shop located relatively close to the nearest station 610 and the event venue 40 is relatively crowded and a waiting time there is long. Also, it is assumed that the event start time 802 of the event that is held in the event venue 40 is 14:00 and the entry available time zone 803 is from 13:30 to 13:55. Then, it is assumed that the user U1 who is the person with the schedule of entry, has purchased the entry qualification information of the event, and has already been registered in the privilege information issuing apparatus 300 has arrived at the nearest station 610 at 12:45 (current time 801) on the event day. The user terminal 100 carried by the user U1 transmits a privilege issuing request to the privilege information issuing apparatus 300 in response to an operation of the user U1. Since the user U1 has succeeded in the face authentication, and the entry qualification information of the user U1 corresponds to the event that is held in the event venue 40 on the day, the privilege information issuing apparatus 300 continues the privilege information issuing processing in Step S307 and subsequent steps in FIG. 13.

In the example of FIG. 15, the privilege information issuing apparatus 300 specifies the event start time 802 and the entry available time zone 803 (S307) and calculates the extra time 804 as 45 minutes to 70 minutes (S308). Then, the privilege information issuing apparatus 300 calculates required total times for a route R1 in a case of traveling from the current position (nearest station 610) of the user U1 to the event venue 40 via the commercial facility 41 and a route R2 in a case of traveling from the nearest station 610 to the event venue 40 via the commercial facility 42. Specifically, the privilege information issuing apparatus 300 acquires information that there are unoccupied seats and the waiting time 813 is 3 minutes as a congestion state of the commercial facility 41 and acquires information that all seats are occupied and the waiting time 823 is 30 minutes as a congestion state of the commercial facility 42 first (S309). Then, the privilege information issuing apparatus 300 calculates a first required travel time 811 through a route R11 from the nearest station 610 to the commercial facility 41 as 5 minutes for the route R1 (S310). For example, the first required travel time 811 is calculated from the distance of the route R11, congestion states at a corner, crossing, a pedestrian bridge, and a road, the number of users of the nearest station 610, and the like. Then, the privilege information issuing apparatus 300 calculates a second required travel time 812 through a route R12 from the commercial facility 41 to the event venue 40 as 7 minutes (S311). Then, the privilege information issuing apparatus 300 calculates an expected staying time 814 at the commercial facility 41 to be 33 minutes to 53 minutes on the basis of the congestion state (S312). Then, the privilege information issuing apparatus 300 calculates the required total time 815 of the route R1 (S313). Here, calculation is performed such that the first required travel time 811 “5 minutes”+the second required travel time 812 “7 minutes”+the expected staying time 814 “33 minutes to 53 minutes”=the required total time 815 “43 minutes to 63 minutes”.

Similarly, a first required travel time 821 through a route R21 from the nearest station 610 to the commercial facility 42 is calculated as 2 minutes, and a second required travel time 822 for a route R22 from the commercial facility 42 to the event venue 40 is calculated as 3 minutes for the route R2. In addition, an expected staying time 824 at the commercial facility 42 is calculated as 60 minutes to 80 minutes. Therefore, calculation is performed such that the first required travel time 821 “2 minutes”+the second required travel time 822 “3 minutes”+the expected staying time 824 “60 minutes to 80 minutes”=the required total time 815 “65 minutes to 85 minutes” for the route R2.

Here, the required total time 815 “43 minutes to 63 minutes” for the route R1 via the commercial facility 41 is within the range of the extra time 804 “45 minutes to 70 minutes” or is shorter than the range. On the other hand, the required total time 825 “65 minutes to 85 minutes” through the route R2 via the commercial facility 42 is longer than the extra time 804 “45 minutes to 70 minutes”. Therefore, the privilege information issuing apparatus 300 selects the commercial facility 41 because the required total time 815 thereof meets the extra time 804 (S314) and issues privilege information (coupon) that can be used in the commercial facility 41 (restaurant A) (S315). In other words, it is possible to state that although the route R2 is more convenient than the route R1 only in terms of the total required travel time from the current position to the event venue 40, the route R1 is more suitable than the route R2 in terms of the expected staying time and the required total time in consideration of the congestion state. Therefore, the eating place A via the route R1 is selected as a target of issuing of the privilege information.

Note that in a case where there are a plurality of commercial facilities, the required total times of which meet the extra time, the corresponding plurality of commercial facilities may be selected as targets of issuing of the privilege information, and privilege information that is common or different and can be used in each commercial facility may be issued. At that time, the stores may be caused to provide notification and display such that priority is identifiable in accordance with the required total times. In addition, the privilege content may be changed in accordance with the extra time.

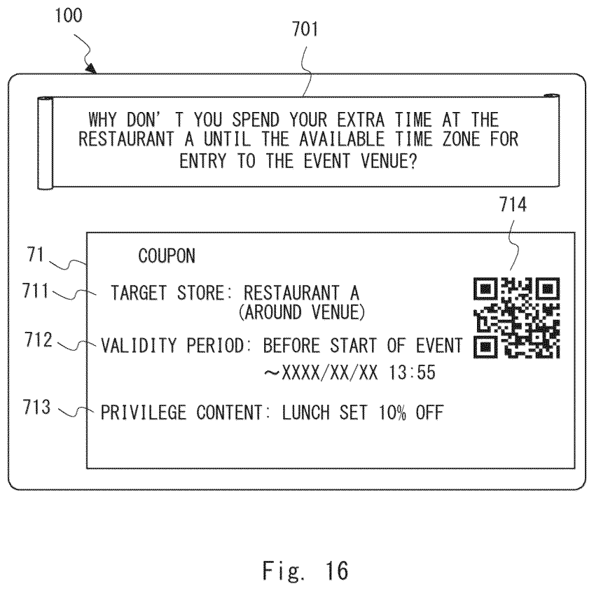

FIG. 16 is a diagram illustrating a display example of privilege information according to the second example embodiment. A notification message 701 is text information included in the privilege information provided through the notification. Although the notification message 701 indicates “why don't you spend your extra time at the restaurant A until the available time zone for entry to the event venue?” here, the notification message 701 is not limited thereto. A coupon 71 displays a target store 711, a validity period 712, privilege content 713, and code information 714. The coupon 71 indicates that the target store 711 is the restaurant A (for example, the commercial facility 41) in the surroundings of the event venue 40 and the validity period 712 is “until 13:55” before the start of the event. The coupon 71 indicates that the privilege content 713 is “lunch set 10% off”. The code information 714 is a two-dimensional code including the privilege ID. Note that the target store 711, the validity period 712, the privilege content 713, and the code information 714 are examples and are not limited thereto.

Note that the privilege information issuing apparatus 300 may notify the user terminal 100 of the information illustrated in FIG. 15 together with the privilege information and the notification message. In other words, the user terminal 100 may display the current time 801, the event start time 802, the entry available time zone 803, the extra time 804, the routes R1 and R2 from the current position to the event venue in the case where each store is dropped by, the waiting time and the expected staying time at each store, the required travel time and the required total time for each route, and the like.

In this manner, the user U1 can ascertain that the coupon 71 can be used at the restaurant A by 13:55 before the start and can be motivated to adjust their schedule at the restaurant A until the start of the event, that is, the user U1 can be motivated by carrying out a consumption action at the restaurant A. Then, the user U1 can use the coupon 71 in payment at the restaurant A and can enjoy the privilege.

For example, the user U1 can select and display the coupon 71 using the user terminal 100 and use the coupon 71 in the restaurant A. At this time, the payment terminal 51 images code information of the code information 714 with the camera 540, analyzes the captured image, extracts the image as a privilege ID, and images the face of the user U1. Then, the payment terminal 51 transmits a face authentication payment request including the face image, the payment target information, the privilege ID, and the terminal information 512 to the privilege information issuing apparatus 300 via the network N. Then, the authentication control unit 342 and the payment control unit 347 of the privilege information issuing apparatus 300 performs the payment processing using the face authentication of the user U1 and the privilege information as described above. In this manner, the commercial facility 41 can get profit due to the end of the event.

Note that the waiting time differs even at the same store depending on the congestion state on the day. Accordingly, the expected staying time and the required total time also vary. Therefore, the store selected in Step S314 may be changed in accordance with the congestion state.

Furthermore, the extra time varies depending on the arrival time of the user U1. Therefore, the service content (a seated style or a standing style, for here or to go) and the privilege content of the store may be dynamically changed in accordance with how long the extra time is.

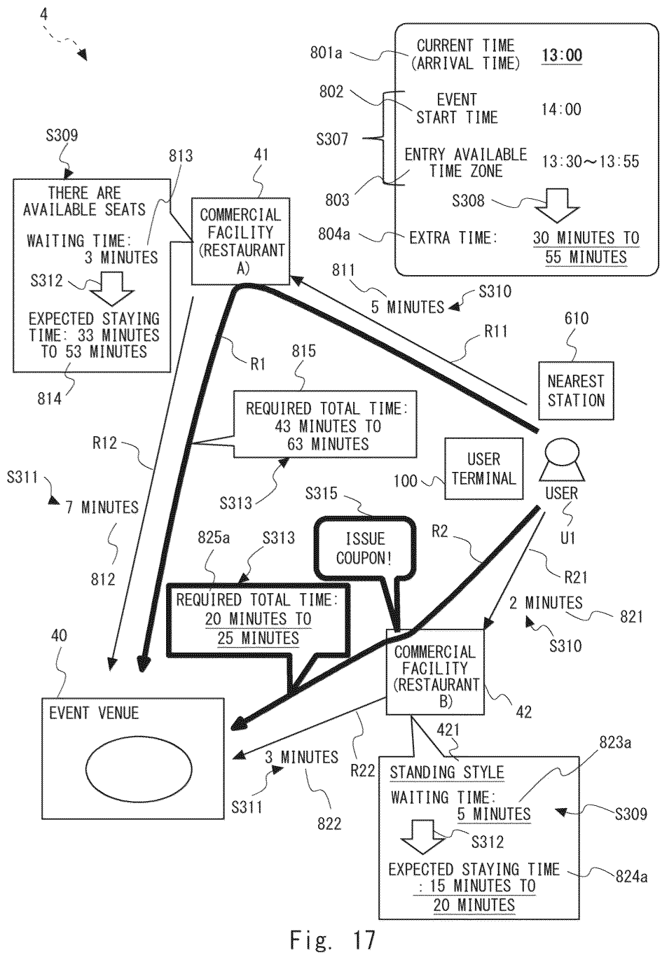

FIG. 17 is a diagram illustrating an example of relationships between positional relationships of the event venue, the commercial facilities in the neighborhood, and the person with the schedule of entry and required times according to the second example embodiment. Here, it is assumed that both the seated style and the standing style are possible and congestion states (waiting times) differ for the seated style (seat) and the standing style at the restaurant B. In this example, it is assumed that the user U1 has arrived at the nearest station 610 at the current time 801a “13:00” and the extra time 804a is “30 minutes to 55 minutes”, which is shorter than that in FIG. 15 described above. In regard to the congestion state of the restaurant B, it is assumed that the waiting time 823a is 5 minutes, which is shorter than that of the seated style (seat). Therefore, the privilege information issuing apparatus 300 changes the style from the seated style to the standing style, and calculates the expected staying time 824a from 15 minutes to 20 minutes and the required total time 825a from 20 minutes to 25 minutes for the commercial facility 42 (S312, S313). Therefore, the privilege information issuing apparatus 300 selects the commercial facility 42 because the required total time 825a meets (is shorter than) the extra time 804a (S314) and issues privilege information (coupon) that can be used in the commercial facility 42 (restaurant B) (S315). On the other hand, the required total time 815 “43 minutes to 63 minutes” of the route R1 via the commercial facility 41 is longer than the extra time 804a “30 minutes to 55 minutes”. Therefore, the coupon that can be used in the restaurant A may not be issued in this case. Note that the privilege information issuing apparatus 300 may select the commercial facility as the target of issuing of the coupon in consideration of the relationships between the first and second required travel times and the expected staying times in addition to the required total times. Specifically, the privilege information issuing apparatus 300 may lower the priority of selecting the commercial facility, the expected staying time of which is significantly shorter than the first and second required travel times, or may exclude the commercial facility from the target of selection. For example, in a case where the total of the first and second required travel times is 30 minutes, and the expected staying time is equal to or less than 30 minutes, the privilege information issuing apparatus 300 may filter the corresponding commercial facilities. Alternatively, the privilege information issuing apparatus 300 may exclude the commercial facilities, the expected staying times of which are equal to or less than 30 minutes, from targets of selection without exception. This is because in a case where the time during which the user can stay there is short, the effect of motivating the user to use the commercial facility by issuing the coupon is lowered.

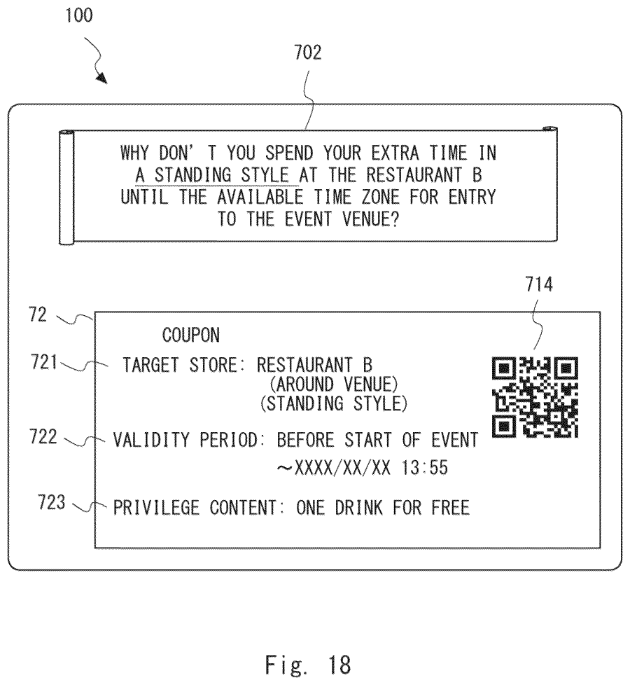

FIG. 18 is a diagram illustrating a display example of privilege information according to the second example embodiment. A notification message 702 is text information included in the privilege information provided through the notification. Although the notification message 702 indicates “why don't you spend your extra time in a standing style at the restaurant B until the available time zone for entry to the event venue?” here, the notification message 702 is not limited thereto. A coupon 72 displays a target store 721, a validity period 722, privilege content 723, and code information 724. The coupon 72 indicates that the target store 721 is the restaurant B (standing style) (for example, the commercial facility 41) in the surroundings of the event venue 40 and the validity period 722 is “until 13:55: before the start of the event. The coupon 72 indicates that the privilege content 723 is “one drink for free”. The code information 724 is a two-dimensional code including the privilege ID. Note that the target store 721, the validity period 722, the privilege content 723, and the code information 724 are examples and are not limited thereto.

In this manner, the user U1 can ascertain that the coupon 72 can be used in the restaurant B by 13:55 before the start even if the extra time is relatively short, for example. Therefore, the user U1 can obtain motivation to adjust their schedule at the restaurant B until the start of the event, that is, motivation to carry out a consumption action at the restaurant B. Then, the user U1 can use the coupon 72 in payment at the restaurant B and can enjoy the privilege. Note that since the above example is a case where the extra time is relatively short, the expected staying time and the required total time may be calculated by choosing “to go” instead of the standing style at the restaurant B.

Note that in the case of FIG. 17, a time (inclusion time) of the required total time 815 “43 minutes to 63 minutes” for the route R1 overlapping the extra time 804a “30 minutes to 55 minutes” is 13 minutes, the required total time 815 may be determined to meet the extra time 804a and a coupon that can be used in the restaurant A may also be issued. In that case, the user terminal 100 may display the coupon 71 that can be used in the restaurant A with a lower priority than that of the coupon 72 that can be used in the restaurant B. Note that the coupon issued as being able to be used in the restaurant B in FIG. 17 may be for “to go” instead of standing style. In a case where the user selects the corresponding coupon, for example, the privilege information issuing apparatus 300 may cause the user terminal to display a menu of the restaurant B, receive an order of the menu from the user, and perform processing of ordering the received menu to the restaurant B. In this manner, the user can get the ordered menu to go in a short waiting time by arriving at the restaurant B and presenting the coupon. In other words, it is possible to further shorten the staying time. In the above description, the user may not only present the coupon of the product ordered in advance if the user arrives at the restaurant B but also present the “order screen and order number” of the product ordered using the coupon for the purpose of getting it to go from the user terminal before arrival to the restaurant B as confirmation of the order.

In this manner, it is possible to assist effective utilization of the spare time before the start of the event for the person with the schedule of entry who has the entry qualification information for the event venue according to the present embodiment as well.

Note that the privilege information issuing apparatus issues the privilege information as described above for the user who has the entry qualification information before the entry to the event venue at this time in principle. However, in a case where the user as the target of issuing of the privilege information has time before the start of event after the entry, the user may temporarily go out from the event venue once and may be allowed to re-enter the event venue through issuing or utilization of the coupon. In other words, the user may acquire qualification information with which re-entry is allowed in a case where the user gets issuing or uses the coupon according to the present embodiment even for an event that generally does not allow re-entry. Specifically, it is only necessary for the privilege information issuing apparatus to issue predetermined code information as qualification information that allows re-entry in the case where the user who has gone out from the event venue gets issuing or uses the privilege information. It is only necessary for the “code information” to be, for example, a two-dimensional code with which face feature information of the user can be specified, a two-dimensional code with which the issued or used coupon can be specified, a two-dimensional code with which the face feature information and the coupon can be specified, or the like. It is assumed that in a case where the user has entered the event venue 2 hours before the event start time and has gone out before the start of the event, for example, the user has operated the user terminal, has gotten issuing of the privilege information, and has used the privilege information in the store in the surroundings. In response to this, the user terminal acquires and displays the code information as the qualification information with which re-entry is allowed. Then, the user is determined to be able to re-enter the event venue through identity authentication (face authentication or code authentication) by holding the code information displayed on the user terminal over an entry control terminal, and the user can re-enter the event venue even after going out from the event venue once.

### Third Example Embodiment

A third example embodiment is a modified example of the second example embodiment described above. An acquisition unit 348 according to the third example embodiment acquires attribute information associated with a person with a schedule of entry who has succeeded in identity authentication. Then, an issuing unit 344 selects a commercial facility as a target of issuing of privilege information from among a plurality of commercial facilities in the neighborhood of an event venue on the basis of the attribute information as well.

In other words, the issuing unit 344 issues the privilege information in accordance with attribute information associated with a user U1. For example, the issuing unit 344 issues the privilege information in which the validity period, the privilege content, and the target facility determined on the basis of the attribute information have been set. In addition, the issuing unit 344 issues the privilege information that grants the privilege content in accordance with the attribute information. In addition, the issuing unit 344 may issue the privilege information that can be used in different facilities in accordance with the attribute information from among the facilities in the neighborhood. For example, the issuing unit 344 may issue a coupon for a facility “cafe” if the attribute information indicates a female, and may issue a coupon of for a facility “ramen shop” if the attribute information indicates a male. It is thus possible to use the facilities in a dispersed manner and to alleviate congestion in the facilities.

Moreover, the issuing unit 344 may select and issue privilege information that satisfy an issuing condition 3134 on the basis of attribute information 3123 and entry qualification information 3125 associated in advance with the user U1 from a privilege information master 313. Note that an overall configuration and an individual configuration of the privilege information issuing system 1000 according to the third example embodiment are similar to those of the second example embodiment described above, and repeated description and illustration will thus be omitted.

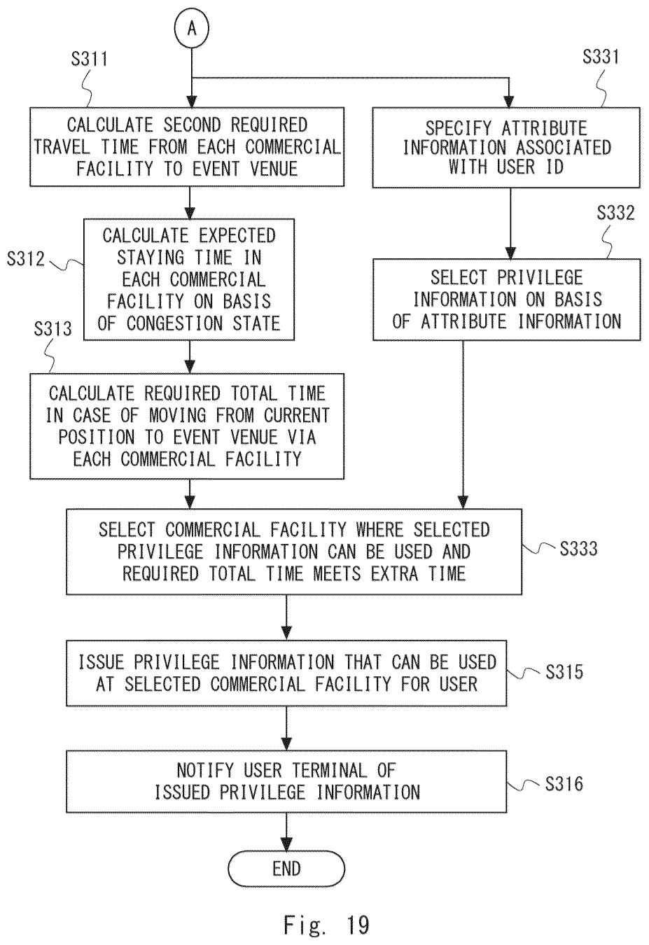

FIG. 19 is a flowchart illustrating a flow of privilege information issuing processing according to the third example embodiment. After Step S310 in FIG. 13 described above, a privilege information issuing apparatus 300 executes Steps S331 and S332 in parallel with Steps S311 to S313. In other words, the privilege information issuing apparatus 300 specifies the attribute information 3123 associated with a user ID 3121 specified in Step S305 from user information 312 (S331). Then, the privilege information issuing apparatus 300 selects the privilege information on the basis of the specified attribute information 3123 (S332).

For example, the privilege information issuing apparatus 300 may select privilege information including suitable privilege content based on the specified attribute information from the privilege information master 313. Specifically, it is only necessary for the privilege information issuing apparatus 300 to specify a set of a privilege ID 3131, a target facility 3132, and privilege content 3133, the specified attribute information and related information thereof are defined in the issuing condition 3134, from the privilege information master 313. For example, the privilege information issuing apparatus 300 may select privilege information with a degree of matching of a generation, a sex, a member rank, a hobby, a preference, an interest, and the like of the user indicated by the attribute information with the content defined in the issuing condition of equal to or greater than a threshold value from a plurality of pieces of privilege information. Furthermore, the privilege information issuing apparatus 300 may appropriately change the target facility 3132 and the privilege content 3133 in the selected privilege information in consideration of the member rank and the like. Note that the privilege information issuing apparatus 300 may determine the privilege content and the target facility in accordance with a seat grade and a ticket price from the entry qualification information 3125 that the user as the target of issuing has purchased and the event ID. Note that the seat grade and the ticket price may be regarded as attribute information of the user as the target of issuing. Alternatively, the privilege information issuing apparatus 300 may dynamically determine (generate) the privilege content on the basis of the specified attribute information.

After Steps S313 and S332, the privilege information issuing apparatus 300 selects the commercial facility where the selected privilege information can be used and the required total time meets the extra time (S333). Specifically, the privilege information issuing apparatus 300 selects the commercial facility such that the required total time in the target facility 3132 associated with the set of the specified privilege ID 3131 and privilege content 3133 meets the extra time, from the privilege information master 313. Thereafter, the privilege information issuing apparatus 300 executes Steps S315 and S316 described above.

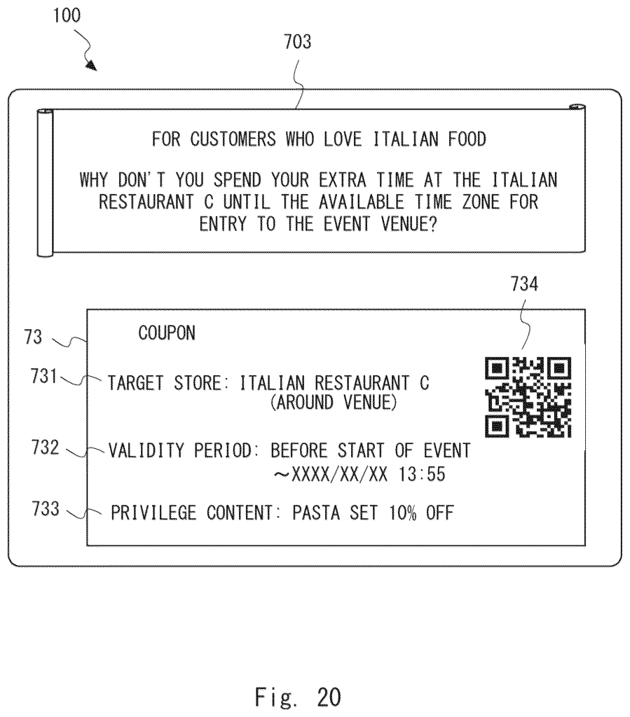

FIG. 20 is a diagram illustrating a display example of privilege information according to the third example embodiment. A notification message 703 is text information included in the privilege information provided through the notification. Although the notification message 703 indicates “For customers who love Italian foods, why don't you spend your extra time at the Italian restaurant C until the available time zone for entry to the event venue?”, the notification message 703 is not limited thereto. A coupon 73 displays a target store 731, a validity period 732, privilege content 733, and code information 734. The coupon 73 indicates that the target store 731 is the Italian restaurant C in the surroundings of the event venue 40 and the validity period 732 is “until 13:55” before the start of the event. The coupon 73 indicates that the privilege content 733 is “pasta set 10% off”. The code information 734 is a two-dimensional code including a privilege ID. Note that the target store 731, the validity period 732, the privilege content 733, and the code information 734 are examples and are not limited thereto.

The above example illustrates that since the fact that the user U1 likes Italian food is specified from the attribute information of the user U1, the Italian restaurant C is selected with higher priority than other stores, and the coupon 73 is issued and provided through the notification.

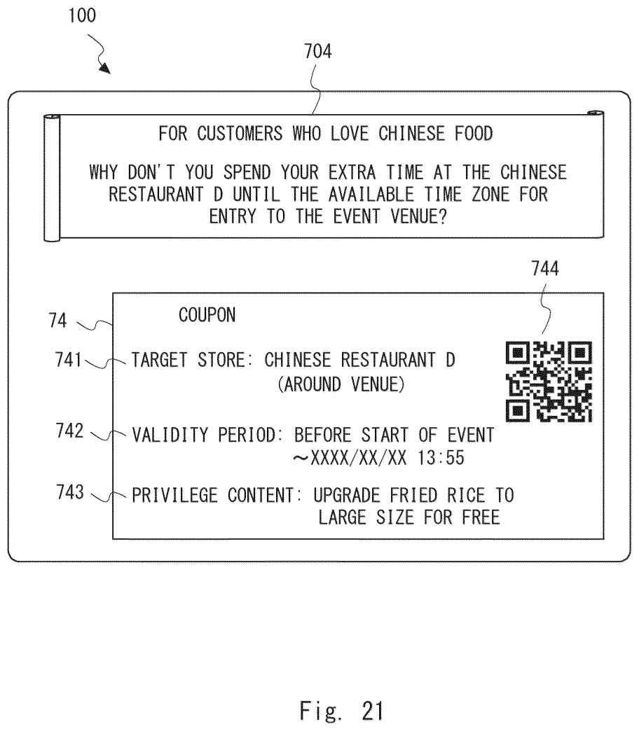

FIG. 21 is a diagram illustrating a display example of privilege information according to the third example embodiment. A notification message 704 is text information included in the privilege information provided through the notification. Although the notification message 704 indicates “For customers who love Chinese food, why don't you spend your extra time at the Chinese restaurant D until the available time zone for entry to the event venue?” here, the notification message 704 is not limited thereto. A coupon 74 displays a target store 741, a validity period 742, privilege content 743, and code information 744. The coupon 74 indicates that the target store 741 is the Chinese restaurant D in the surroundings of the event venue 40 and the validity period 742 is “until 13:55” before the start of the event. The privilege content 743 indicates that the privilege content 743 is “upgrade fried rice to large size for free”. The code information 744 is a two-dimensional code including the privilege ID. Note that the target store 741, the validity period 742, the privilege content 743, and the code information 744 are examples and are not limited thereto.

The above example illustrates that since the fact that the user U1 likes Chinese food is specified from the attribute information of the user U1, the Chinese restaurant D is selected with higher priority than other stores, and the coupon 74 is issued and provided as a notification.

In this manner, since the store as the target of issuing of the coupon is selected in consideration of the attribute of the user, the utilization of the commercial facilities in the neighborhood of the event venue 40 is further promoted according to the present embodiment.

### Fourth Example Embodiment

A fourth example embodiment is a modified example of the second or third example embodiment described above. In the fourth example embodiment, a case where a privilege issuing request is provided if the user considers the arrival time at a nearest station 610 in advance rather than if the user U1 arrives at the nearest station 610 on the day of the event will be described.

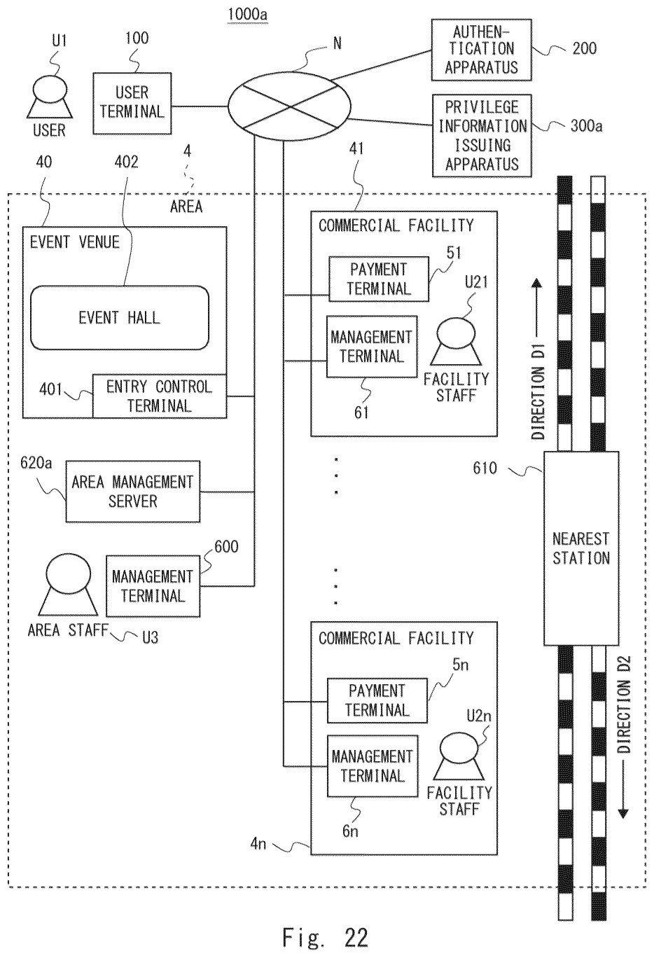

FIG. 22 is a block diagram illustrating an overall configuration of a privilege information issuing system 1000a according to the fourth example embodiment. In the privilege information issuing system 1000a, a user U1 and a user terminal 100 are outside an area 4, and a privilege information issuing apparatus 300a and an area management server 620a are changed, as compared with FIG. 3 described above. It is assumed that the area management server 620a can predict a congestion state at each commercial facility 41 or the like on a day on which an event will be held in the future from accumulated data of past congestion states and provide prediction information on the congestion state in response to an inquiry, in addition to the functions of the area management server 620 described above. In a case where the privilege information issuing apparatus 300a receives a privilege issuing request including a scheduled arrival time instead of a current position, the privilege information issuing apparatus 300a calculates an extra time from the scheduled arrival time to an entry available time zone. In addition, the privilege information issuing apparatus 300a acquires the prediction information on the congestion state from the scheduled arrival time to the entry available time zone from the area management server 620a and issues privilege information in consideration of the prediction information on the congestion state. Note that other configurations and individual configurations of the privilege information issuing system 1000a according to the fourth example embodiment are similar to those in the second example embodiment described above, and repeated description and illustration will thus be omitted.

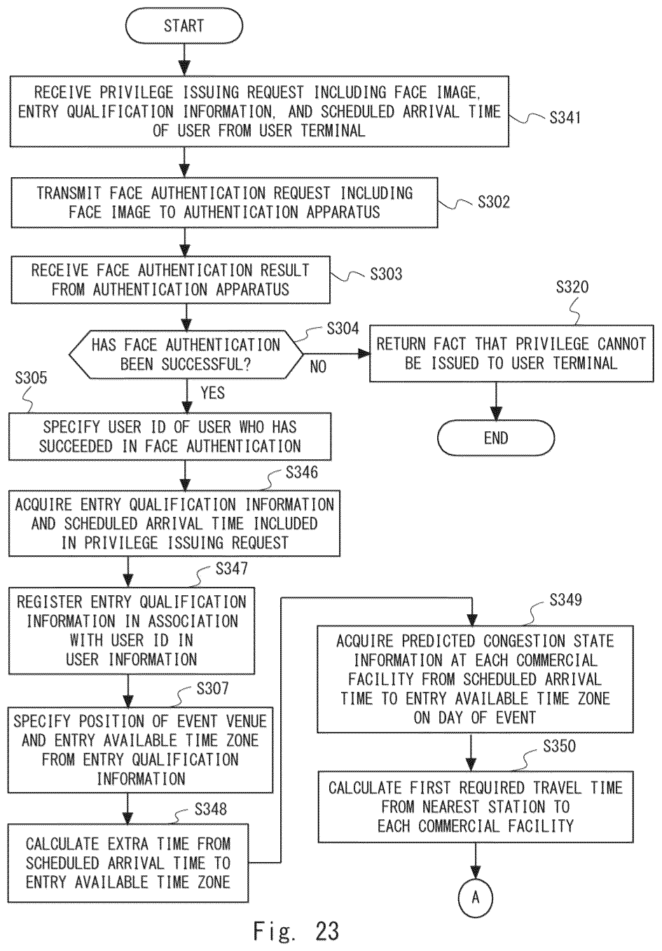

FIG. 23 is a flowchart illustrating a flow of privilege information issuing processing according to the fourth example embodiment. Here, it is assumed for the user U1 that although the member information registration processing in FIG. 9 described above has been completed and the entry qualification information has already been purchased, registration in the privilege information issuing apparatus 300a has not yet been performed.

Thus, the user terminal 100 acquires the entry qualification information purchased by the user U1 and the scheduled arrival time on the day of the event and images the face of the user U1 in response to an instruction of a privilege issuing request. Then, the user terminal 100 transmits the privilege issuing request including the face image, the entry qualification information, and the scheduled arrival time to the privilege information issuing apparatus 300a via the network N.

In response to the transmission, the privilege information issuing apparatus 300a receives the privilege issuing request including the face image, the entry qualification information, and the scheduled arrival time of the user from the user terminal (S341). Then, the privilege information issuing apparatus 300a executes Steps S302 to S305 described above. Subsequently, the privilege information issuing apparatus 300a acquires the entry qualification information and the scheduled arrival time included in the privilege issuing request (S346). Then, the privilege information issuing apparatus 300a associates entry qualification information 3125 with a specified user ID 3121 and registers them in user information 312 (S347).

Then, the privilege information issuing apparatus 300a calculates an extra time from the scheduled arrival time to the entry available time zone (S348). In other words, the privilege information issuing apparatus 300a calculates the extra time from the scheduled arrival time of the person with the schedule of entry to the area 4 to the clock time that is attributable to the start of the event on the basis of the entry qualification information 3125. Then, the privilege information issuing apparatus 300a acquires prediction information on the congestion state from the scheduled arrival time to the entry available time zone at each commercial facility on the day of the event (S349). Specifically, the privilege information issuing apparatus 300a transmits a request for acquiring prediction information on the congestion state designating the area 4, the scheduled arrival time, and the entry available time zone to the area management server 620a. Then, the privilege information issuing apparatus 300a acquires the prediction information on the congestion state from the scheduled arrival time to the entry available time zone at each commercial facility on the day of the event from the area management server 620a. Then, the privilege information issuing apparatus 300a calculates a first required travel time from the nearest station 610 to each commercial facility, for example (S350). Note that the privilege information issuing apparatus 300a may regard an arbitrary point in the event venue 40, the nearest station 610, or the area 4 as a travel start point of the person with the schedule of entry and calculate the first required travel time. Thereafter, the privilege information issuing apparatus 300a executes Steps S311 to S316 in FIG. 14 described above.

In this manner, the user U1 can acquire the coupon that can be used in the commercial facility in the neighborhood where the user can adjust their schedule before the start of the event before arrival at the nearest station 610 on the day of the event, easily make a plan, and effectively use the extra time.

Note that the aforementioned privilege issuing request may not necessarily include the scheduled arrival time. In other words, the privilege information issuing apparatus 300a may not acquire the scheduled arrival time from the user terminal 100 in the privilege information issuing processing. In that case, the user U1 can use the privilege information issuing apparatus 300a if the user U1 considers the scheduled arrival time on the day of the event. For example, the privilege information issuing apparatus 300a may execute Step S346 and subsequent steps in FIG. 23 for a plurality of scheduled arrival times and provide a notification of privilege information for each scheduled arrival time. At this time, the user terminal 100 may display examples of routes and times as in FIGS. 15 and 17 described above for each scheduled arrival time along with the privilege information. In other words, the privilege information issuing apparatus 300a may propose the scheduled arrival time on the day of the event and the store and the coupon that can be used before the start of the event to the user U1 in a prior privilege issuing request. In this manner, the user U1 can easily determine the scheduled arrival time and make a schedule in consideration of the privilege information.

Alternatively, in a case where the scheduled arrival time is not included in the privilege issuing request, the privilege information issuing apparatus 300a may not obtain the route R11 and the route R21 in the privilege information issuing processing and may not calculate the first required travel time. In other words, the privilege information issuing apparatus 300a may calculate the required total time using the second required travel time and the expected staying time.

### Other Example Embodiments

Note that the privilege issuing request according to the second or third example embodiment described above may not necessarily include the current position of the user terminal 100. In other words, the privilege information issuing apparatus 300 may not acquire the current position from the user terminal 100 in the privilege information issuing processing. The reason is that the user U1 desires to adjust their schedule in the commercial facility in the neighborhood that is not that far from the event venue 40, that is, inside the area 4, the travel start point is limited, and there may be no big difference in first required travel time of each commercial facility. Thus, the privilege information issuing apparatus 300 may regard an arbitrary point in the event venue 40, the nearest station 610, or the area 4 as the travel start point of the person with the schedule of entry and calculate the first required travel time in the case where the privilege issuing request does not include the current position. Alternatively, the privilege information issuing apparatus 300 may not obtain the route R11 and the route R21 and may not calculate the first required travel time in the case where the privilege issuing request does not include the current position. In other words, the privilege information issuing apparatus 300 may calculate the required total time using the second required travel time and the expected staying time.

Furthermore, in a case where the current position is not acquired from the user terminal 100, Step S306 and subsequent steps in FIG. 13 may be executed continuously from Step S127 in FIG. 11 described above.

Note that in issuing of the privilege information may not be triggered only by the privilege issuing request from the user terminal and the privilege information may be recommended for the user by being triggered by the side of the privilege information issuing apparatus 300. Specifically, the privilege information issuing apparatus 300 may pick up the user as the target of issuing of the privilege information several hours before the event start time, issue a coupon that can be used in the facility in the surroundings of the event venue before the start of the event, and notify the user terminal of the user picked up of the issued coupon. Note that the privilege information issuing apparatus 300 may or may not acquire the position information from the user terminal in a case where the coupon is issued.

In addition, in a case where there are a plurality of commercial facilities that satisfy the privilege information issuing condition, the privilege information issuing apparatus 300 may notify the user terminal of a plurality of pieces of privilege information including the expected staying time, the required total time, the privilege content (the product, the service, or the like that can be purchased. Then, the privilege information issuing apparatus 300 may issue privilege information selected by the user.

Note that although the example in which the user U1 arrives in the area 4 using a railway has been illustrated in the aforementioned example embodiments, the means for moving to the area 4 is not limited thereto. For example, the user U1 may travel to the area 4 by bus, aircraft, taxi, ship, own vehicle, bicycle, on foot, or the like.

Note that the aforementioned example embodiments have been described on the assumption that the identity authentication is based on the face authentication, the present disclosure is not limited thereto. In addition, although the description has been made on the assumption that the payment processing is based on the face authentication payment, the present disclosure may be applied to another payment method. In addition, the identity authentication at the time of issuing of the privilege information, the identity authentication at the time of entry or exiting of the event venue, and the identity authentication at the time of utilization of the privilege information in the commercial facility in the neighborhood of the event venue are also not limited to face authentication, and other identity authentication, which will be described later, may be applied.

In addition, although the aforementioned embodiments have been described on the assumption that the identity authentication (authentication for checking the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that although the second example embodiment and the like are described on the assumption that the authentication apparatus 200 and the privilege information issuing apparatus 300 are different information processing apparatuses, the authentication apparatus 200 and the privilege information issuing apparatus 300 may be the same information processing apparatus. For example, the privilege information issuing apparatus 300 may further register the face feature information in association with the user ID 3121 of the user information 312. In this case, the control unit 340 only needs to further have the functions of the face detection unit 220, the feature point extraction unit 230, the registration unit 240, and the authentication unit 250 in FIG. 4.

Note that in the entry qualification information registration processing in FIG. 11 described above, the entry qualification information may not necessarily be registered using the success in face authentication as a condition. Alternatively, in a case where the user ID issued at the time of registration of the user information is stored in the user terminal, the user terminal may transmit a registration request including the user ID and the entry qualification information instead of the face image to the privilege information issuing apparatus 300 in Step S123. In that case, the privilege information issuing apparatus 300 may register the user ID and the entry qualification information included in the received registration request in an associated manner in user information. Alternatively, a sales server of the entry qualification information may transmit a registration request including the user ID and the entry qualification information of the purchaser to the privilege information issuing apparatus 300 at the time of purchasing the entry qualification information, and cause the privilege information issuing apparatus 300 to register the user ID and the entry qualification information.

Note that the entry qualification information registration processing in FIG. 11 described above may be performed by an information registration terminal instead of the user terminal 100. The information registration terminal may be, for example, a KIOSK terminal installed in a station or a commercial facility. In this case, the user terminal 100 transfers the entry qualification information to the KIOSK terminal, for example. Alternatively, the user inputs the entry qualification information to the KIOSK terminal. Then, the KIOSK terminal transmits the acquired entry qualification information and a face image obtained by imaging the user with the KIOSK terminal to the privilege information issuing apparatus 300. Note that in a case where a current location is used to issue the privilege information, the position information of the KIOSK terminal may be used. In addition, it is only necessary for the privilege information issuing apparatus 300 to notify the KIOSK terminal of the issued privilege information. At this time, the KIOSK terminal may display code information or the like of the privilege information such that the code information can be visually recognized by the user, and the user terminal may acquire the privilege information by scanning the code information displayed on the screen of the KIOSK terminal. Alternatively, the KIOSK terminal may print and output the code information or the like of the received privilege information. Alternatively, the privilege information issuing apparatus 300 may provide a notification of the privilege information issued with respect to the terminal information (user terminal) of the user specified by face authentication.

Note that the event venue may be replaced with an accommodation facility or an airport and the aforementioned embodiments may be applied to effectively use a spare time before a check-in time or a waiting time for transit.

Note that the aforementioned issuing unit may select privilege information in accordance with attributes of the event, and issue and present the privilege information and notify the user of the privilege information. For example, in a case where the event is a sport game, a coupon that can be used at a support goods store may be issued to guide the user to the sales store. In addition, in a case where the event is a test, a coupon that can be used in a quiet cafe may be issued to guide the user to the cafe.

In the above-described example, the program includes a group of instructions (or software code) for causing a computer to perform one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### (Supplementary Note A1)

A privilege information issuing apparatus including:
an acquisition means for acquiring entry qualification information with which a person with a schedule of entry to an event venue where a predetermined event is held is able to enter the event venue through identity authentication;
a calculation means for calculating an extra time until a clock time that is attributable to a start of the event from a clock time at which the person with the schedule of entry is scheduled to arrive or arrives in a predetermined region including the event venue on the basis of the entry qualification information;
an issuing means for issuing privilege information that is able to be used in one or more commercial facilities in a neighborhood of the event venue on the basis of the extra time; and
a notification means for notifying a terminal of the person with the schedule of entry of the issued privilege information.

### (Supplementary Note A2)

The privilege information issuing apparatus according to Supplementary Note A1, in which the issuing means selects a commercial facility as a target of issuing of the privilege information from among a plurality of commercial facilities in the neighborhood of the event venue on the basis of the extra time, and issues the privilege information that is able to be used in the selected commercial facility.

### (Supplementary Note A3)

The privilege information issuing apparatus according to Supplementary Note A2, in which the issuing means selects the commercial facility as the target of issuing of the privilege information from among the plurality of commercial facilities on the basis of a relationship of a first required travel time from a travel start point to the commercial facility, an expected staying time at the commercial facility, and a second required travel time from the commercial facility to the event venue with the extra time of the person with the schedule of entry.

### (Supplementary Note A4)

The privilege information issuing apparatus according to Supplementary Note A2 or A3, in which
the acquisition means acquires congestion states of the plurality of commercial facilities in a time zone of the extra time, and
the issuing means selects the commercial facility as the target of issuing of the privilege information from among the plurality of commercial facilities also on the basis of the congestion states.

### (Supplementary Note A5)

The privilege information issuing apparatus according to any one of Supplementary Notes A1 to A4, in which
the acquisition means further acquires a current position of the person with the schedule of entry who has arrived in the predetermined region, and
the issuing means selects the commercial facility as the target of issuing of the privilege information from among the plurality of commercial facilities in the neighborhood of the event venue on the basis of the current position as well.

### (Supplementary Note A6)

The privilege information issuing apparatus according to any one of Supplementary Notes A1 to A5, in which
the acquisition means acquires attribute information associated with the person with the schedule of entry who has succeeded in the identity authentication, and
the issuing means selects the commercial facility as the target of issuing of the privilege information from among the plurality of commercial facilities in the neighborhood of the event venue on the basis of the attribute information as well.

### (Supplementary Note A7)

The privilege information issuing apparatus according to any one of Supplementary Notes A1 to A6, in which the acquisition means acquires the entry qualification information associated with the person with the schedule of entry who has succeeded in the identity authentication.

### (Supplementary Note B1)

A privilege information issuing system including:
a storage apparatus that stores entry qualification information with which a person with a schedule of entry is able to enter an event venue where a predetermined event is held through identity authentication, identity authentication information of the person with the schedule of entry who has purchased the entry qualification information, and a terminal that the person with the schedule of entry carries with himself/herself in an associated manner; and
a privilege information issuing apparatus that is connected to the storage apparatus,
in which the privilege information issuing apparatus includes
an acquisition means for acquiring the entry qualification information,
a calculation means for calculating an extra time until a clock time that is attributable to a start of the event from a clock time at which the person with the schedule of entry is scheduled to arrive or arrives in a predetermined region including the event venue on the basis of the entry qualification information,
an issuing means for issuing privilege information that is able to be used in one or more commercial facilities in a neighborhood of the event venue on the basis of the extra time, and
a notification means for notifying a terminal of the person with the schedule of entry of the issued privilege information.

### (Supplementary Note B2)

The privilege information issuing system according to Supplementary Note B1, in which the issuing means selects a commercial facility as a target of issuing of the privilege information from among a plurality of commercial facilities in the neighborhood of the event venue on the basis of the extra time, and issues the privilege information that is able to be used in the selected commercial facility.

### (Supplementary Note C1)

A privilege information issuing method including, by a computer:
acquiring entry qualification information with which a person with a schedule of entry to an event venue where a predetermined event is held is able to enter the event venue through identity authentication;
calculating an extra time until a clock time that is attributable to a start of the event from a clock time at which the person with the schedule of entry is scheduled to arrive or arrives in a predetermined region including the event venue on the basis of the entry qualification information;
issuing privilege information that are able to be used in one or more commercial facilities in a neighborhood of the event venue on the basis of the extra time; and
notifying a terminal of the person with the schedule of entry of the issued privilege information.

### (Supplementary Note D1)

A non-transitory computer-readable medium that stores a privilege information issuing program that causes a computer to execute:
acquisition processing of acquiring entry qualification information with which a person with a schedule of entry to an event venue where a predetermined event is held is able to enter the event venue through identity authentication;
calculation processing of calculating an extra time until a clock time that is attributable to a start of the event from a clock time at which the person with the schedule of entry is scheduled to arrive or arrives in a predetermined region including the event venue on the basis of the entry qualification information;
issuing processing of issuing privilege information that are able to be used in one or more commercial facilities in a neighborhood of the event venue on the basis of the extra time; and
notification processing of notifying a terminal of the person with the schedule of entry of the issued privilege information.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 PRIVILEGE INFORMATION ISSUING APPARATUS
11 ACQUISITION UNIT
12 CALCULATION UNIT
13 ISSUING UNIT
14 NOTIFICATION UNIT
1000 PRIVILEGE INFORMATION ISSUING SYSTEM
N NETWORK
U1 USER
U21 FACILITY STAFF
U2n FACILITY STAFF
U3 AREA STAFF
100 USER TERMINAL
110 STORAGE UNIT
111 PROGRAM
112 TERMINAL INFORMATION
113 POSITION INFORMATION
120 MEMORY
130 COMMUNICATION UNIT
140 CAMERA
150 TOUCH PANEL
160 CONTROL UNIT
161 REGISTRATION UNIT
162 PRIVILEGE PROCESSING UNIT
170 POSITION INFORMATION ACQUISITION UNIT
200 AUTHENTICATION APPARATUS
210 FACE INFORMATION DB
211 USERID
212 FACE FEATURE INFORMATION
220 FACE DETECTION UNIT
230 FEATURE POINT EXTRACTION UNIT
240 REGISTRATION UNIT
250 AUTHENTICATION UNIT
300 PRIVILEGE INFORMATION ISSUING APPARATUS
310 STORAGE UNIT
311 PROGRAM
312 USER INFORMATION
3121 USER ID
3122 TERMINAL INFORMATION
3123 ATTRIBUTE INFORMATION
3124 PAYMENT INFORMATION
3125 ENTRY QUALIFICATION INFORMATION
313 PRIVILEGE INFORMATION MASTER
3131 PRIVILEGE ID
3132 TARGET FACILITY
3133 PRIVILEGE CONTENT
3134 ISSUING CONDITION
314 EVENT INFORMATION
315 PRIVILEGE MANAGEMENT INFORMATION
3151 ISSUED PRIVILEGE ID
3152 USER ID
3153 ISSUING DATE AND TIME
3154 VALIDITY PERIOD
320 MEMORY
330 COMMUNICATION UNIT
340 CONTROL UNIT
341 REGISTRATION UNIT
342 AUTHENTICATION CONTROL UNIT
343 SPECIFICATION UNIT
344 ISSUING UNIT
345 NOTIFICATION UNIT
346 ENTRY DETERMINATION UNIT
347 PAYMENT CONTROL UNIT
348 ACQUISITION UNIT
349 CALCULATION UNIT
4 AREA
40 EVENT VENUE
401 ENTRY CONTROL TERMINAL
402 EVENT HALL
41 COMMERCIAL FACILITY
51 PAYMENT TERMINAL
61 MANAGEMENT TERMINAL
42 COMMERCIAL FACILITY
4n COMMERCIAL FACILITY
5n PAYMENT TERMINAL
6n MANAGEMENT TERMINAL
600 MANAGEMENT TERMINAL
610 NEAREST STATION
620 AREA MANAGEMENT SERVER
410 STORAGE UNIT
411 PROGRAM
412 TERMINAL INFORMATION
420 MEMORY
430 COMMUNICATION UNIT
440 CAMERA
450 TOUCH PANEL
460 CONTROL UNIT
461 RECEPTION UNIT
462 ENTRY CONTROL UNIT
510 STORAGE UNIT
511 PROGRAM
512 TERMINAL INFORMATION
520 MEMORY
530 COMMUNICATION UNIT
540 CAMERA
550 TOUCH PANEL
560 CONTROL UNIT
561 RECEPTION UNIT
562 PAYMENT CONTROL UNIT
701 NOTIFICATION MESSAGE
71 COUPON
711 TARGET STORE
712 VALIDITY PERIOD
713 PRIVILEGE CONTENT
714 CODE INFORMATION
702 NOTIFICATION MESSAGE
72 COUPON
721 TARGET STORE
722 VALIDITY PERIOD
723 PRIVILEGE CONTENT
724 CODE INFORMATION
703 NOTIFICATION MESSAGE
73 COUPON
731 TARGET STORE
732 VALIDITY PERIOD
733 PRIVILEGE CONTENT
734 CODE INFORMATION
704 NOTIFICATION MESSAGE
74 COUPON
741 TARGET STORE
742 VALIDITY PERIOD
743 PRIVILEGE CONTENT
744 CODE INFORMATION
801 CURRENT TIME
802 EVENT START TIME
803 ENTRY AVAILABLE TIME ZONE
804 EXTRA TIME
811 FIRST REQUIRED TRAVEL TIME
812 SECOND REQUIRED TRAVEL TIME
813 WAITING TIME
814 EXPECTED STAYING TIME
815 REQUIRED TOTAL TIME
821 FIRST REQUIRED TRAVEL TIME
822 SECOND REQUIRED TRAVEL TIME
823 WAITING TIME
824 EXPECTED STAYING TIME
825 REQUIRED TOTAL TIME
R1 ROUTE
R11 ROUTE
R12 ROUTE
R2 ROUTE
R21 ROUTE
R22 ROUTE
801a CURRENT TIME
804a EXTRA TIME
823a WAITING TIME
824a EXPECTED STAYING TIME
825a REQUIRED TOTAL TIME
1000a PRIVILEGE INFORMATION ISSUING SYSTEM
300a PRIVILEGE INFORMATION ISSUING APPARATUS
620a AREA MANAGEMENT SERVER

What is claimed is:

1. A privilege information issuing apparatus comprising:
at least one storage device configured to store instructions; and
at least one processor configured to execute the instructions to:
acquire entry qualification information with which a person with a schedule of entry to an event venue where a predetermined event is held is able to enter the event venue through identity authentication;
calculate an extra time until a clock time that is attributable to a start of the event from a clock time at which the person with the schedule of entry is scheduled to arrive or arrives in a predetermined region including the event venue on the basis of the entry qualification information;
issue privilege information that is able to be used in one or more commercial facilities in a neighborhood of the event venue on the basis of the extra time; and
notify a terminal of the person with the schedule of entry of the issued privilege information.

2. The privilege information issuing apparatus according to claim 1, wherein the at least one processor is further configured to execute the instructions to:
select a commercial facility as a target of issuing of the privilege information from among a plurality of commercial facilities in the neighborhood of the event venue on the basis of the extra time, and issue the privilege information that is able to be used in the selected commercial facility.

3. The privilege information issuing apparatus according to claim 2, wherein the at least one processor is further configured to execute the instructions to:
select the commercial facility as the target of issuing of the privilege information from among the plurality of commercial facilities on the basis of a relationship of a first required travel time from a travel start point to the commercial facility, an expected staying time at the commercial facility, and a second required travel time from the commercial facility to the event venue with the extra time of the person with the schedule of entry.

4. The privilege information issuing apparatus according to claim 2, wherein the at least one processor is further configured to execute the instructions to:
acquire congestion states of the plurality of commercial facilities in a time zone of the extra time, and
select the commercial facility as the target of issuing of the privilege information from among the plurality of commercial facilities on the basis of the congestion states as well.

5. The privilege information issuing apparatus according to claim 1, wherein the at least one processor is further configured to execute the instructions to:
acquire a current position of the person with the schedule of entry who has arrived in the predetermined region, and
select the commercial facility as the target of issuing of the privilege information from among the plurality of commercial facilities in the neighborhood of the event venue on the basis of the current position as well.

6. The privilege information issuing apparatus according to claim 1, wherein the at least one processor is further configured to execute the instructions to:
acquire attribute information associated with the person with the schedule of entry who has succeeded in the identity authentication, and
select the commercial facility as the target of issuing of the privilege information from among the plurality of commercial facilities in the neighborhood of the event venue on the basis of the attribute information as well.

7. The privilege information issuing apparatus according to claim 1, wherein the at least one processor is further configured to execute the instructions to:
acquire the entry qualification information associated with the person with the schedule of entry who has succeeded in the identity authentication.

8. A privilege information issuing system comprising:
a storage apparatus that stores entry qualification information with which a person with a schedule of entry is able to enter an event venue where a predetermined event is held through identity authentication, identity authentication information of the person with the schedule of entry who has purchased the entry qualification information, and a terminal that the person with the schedule of entry carries with himself/herself in an associated manner; and
a privilege information issuing apparatus that is connected to the storage apparatus, and including:
at least one storage device configured to store instructions; and
at least one processor configured to execute the instructions to:
acquire the entry qualification information,
calculate an extra time until a clock time that is attributable to a start of the event from a clock time at which the person with the schedule of entry is scheduled to arrive or arrives in a predetermined region including the event venue on the basis of the entry qualification information,
issue privilege information that is able to be used in one or more commercial facilities in a neighborhood of the event venue on the basis of the extra time, and
notify a terminal of the person with the schedule of entry of the issued privilege information.

9. The privilege information issuing system according to claim 8, wherein the at least one processor is further configured to execute the instructions to:
select a commercial facility as a target of issuing of the privilege information from among a plurality of commercial facilities in the neighborhood of the event venue on the basis of the extra time, and issue the privilege information that is able to be used in the selected commercial facility.

10. A privilege information issuing method comprising, by a computer:
acquiring entry qualification information with which a person with a schedule of entry to an event venue where a predetermined event is held is able to enter the event venue through identity authentication;
calculating an extra time until a clock time that is attributable to a start of the event from a clock time at which the person with the schedule of entry is scheduled to arrive or arrives in a predetermined region including the event venue on the basis of the entry qualification information;
issuing privilege information that is able to be used in one or more commercial facilities in a neighborhood of the event venue on the basis of the extra time; and
notifying a terminal of the person with the schedule of entry of the issued privilege information.

11. A non-transitory computer-readable medium that stores a privilege information issuing program that causes a computer to execute:
acquisition processing of acquiring entry qualification information with which a person with a schedule of entry to an event venue where a predetermined event is held is able to enter the event venue through identity authentication;
calculation processing of calculating an extra time until a clock time that is attributable to a start of the event from a clock time at which the person with the schedule of entry is scheduled to arrive or arrives in a predetermined region including the event venue on the basis of the entry qualification information;
issuing processing of issuing privilege information that is able to be used in one or more commercial facilities in a neighborhood of the event venue on the basis of the extra time; and
notification processing of notifying a terminal of the person with the schedule of entry of the issued privilege information.
